(19) United States
(12) Patent Application Publication
(10) Pub. No.: US 2025/0051553 A1
(43) Pub. Date: Feb. 13, 2025

(54) BIO COMPOSITIONS AND METHODS FOR MAKING SAME

(71) Applicant: ATACAMA BIOMATERIALS INC., Cambridge, CA (US)

(72) Inventors: Paloma GONZALEZ ROJAS, Cambridge, MA (US); Jose Tomas DOMINGUEZ FUENZALIDA, Cambridge, MA (US)

(21) Appl. No.: 18/602,385

(22) Filed: Mar. 12, 2024

Related U.S. Application Data
(63) Continuation of application No. PCT/US2022/043889, filed on Sep. 16, 2022.
(60) Provisional application No. 63/245,469, filed on Sep. 17, 2021.

(51) Int. Cl. C08L 3/02; C08K 5/053; C08K 5/09; C08L 1/02

(52) U.S. Cl. CPC C08L 3/02; C08K 5/053; C08K 5/09; C08L 1/02; C08L 2201/06; C08L 2205/06; C08L 2205/16

(57) ABSTRACT

The disclosure provides compositions that can include a variety of components, including fibrous material, polysaccharide, and/or a plasticizer. Methods for generating the compositions are also provided.

### CROSS-REFERENCE

This application is a continuation of International Patent Application No. PCT/US2022/043889, filed Sep. 16, 2022, which claims priority to U.S. Provisional Patent Application No. 63/245,469 filed Sep. 17, 2021, which is herein incorporated by reference in its entirety for all purposes.

### BACKGROUND

Plastic packaging has a harmful environmental impact. Current plastic alternatives have not met basic characteristics that users look for, including cost (e.g., both material and the operational), performance (e.g., durability, flexibility, water resistance), scalability, and sustainability. As such, the current demand for plastic alternatives, approximately 45 million tons annually, is unmet. This market shortage leaves consumer goods, logistics, construction, and e-commerce companies unable to meet their goals.

### SUMMARY

Recognized herein is a need for plastic alternative materials and methods for making such materials. The disclosure provides both.

An aspect of the disclosure provides a composition. The composition comprises a fibrous material; a gelatinization agent; a polysaccharide; and a plasticizer, where the fibrous material and the plasticizer are present at a weight-percent ratio of fibrous material to plasticizer from about 0.01 to about 10. In some embodiments, the fibrous material is cellulose or derivative thereof (e.g., anhydrocellulose). In some embodiments, the fibrous material is a natural fiber. In some embodiments, the polysaccharide is starch or derivative thereof. In some embodiments, the plasticizer is selected from the group consisting of glycerol, maltose, urea, sorbitol, sucrose, fructose, glucose, formamide, citric acid, amino acid, malic acid, ethylenebisformamide, buriti oil, polyethylene glycol, acetamide, ethanolamine, isoleucine, asparagine, ethanolamine, polyoils, lecithin, monoglycerides, propylene glycol, diethyleneoxide glycol, triethyleneoxide glycol and poliethyleneoxide glycol. In some embodiments, the plasticizer is glycerol or derivative thereof.

In some embodiments, the composition comprises a chemical structure as follows:

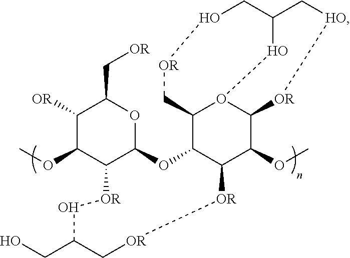

where R is an acetyl group or hydrogen. In some embodiments, n is from about 1 to about 500.

In some embodiments, the composition comprises a chemical structure as follows:

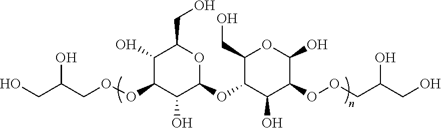

In some embodiments, n is from about 1 to about 500.

In some embodiments, the composition comprises a chemical structure as follows:

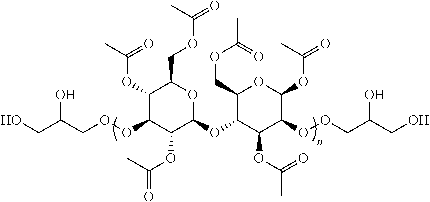

In some embodiments, n is from about 1 to about 500.

In some embodiments, the plasticizer is coupled to the fibrous material via a non-covalent linkage. In some embodiments, the non-covalent linkage is a hydrogen bond. In some embodiments, the material is coupled to the fibrous material via a covalent linkage such as, for example, a glycosidic bond.

In some embodiments, the fibrous material is chemically networked with the polysaccharide via the plasticizer. In some embodiments, the fibrous material and the polysaccharide are present at a weight-percent ratio of fibrous material to polysaccharide from about 0.01 to about 10. In some embodiments, the composition is recyclable. In some embodiments, the gelatinization agent is water. In some embodiments, the polysaccharide and the gelatinization agent are present at a weight-percent ratio of polysaccharide to gelatinization agent from about 0.0001 to about 1. In some embodiments, the fibrous material and the gelatinization agent are present at a weight-percent ratio of fibrous material to gelatinization agent from about 0.0001 to about 1.

In some embodiments, the composition comprises acetic acid.

In some embodiments, the composition comprises a tensile strength of between about 0.1 megapascal (MPa) to about 200 (MPa). In some embodiments, the composition as an elasticity of between about 0.1% and 1000%. In some embodiments, the composition comprises a modulus of elasticity of between 0.1 MPa to 2000 MPa. In some embodiments, the composition comprises a tear propagation of between about 0.1 newtons (N) to about 50 N. In some embodiments, the composition comprises a dynamic viscosity of between about 100 centipoise (cP) to about 5,000,000 cP. In some embodiments, the composition comprises a puncture strength of between about 1 N to about 75 N. In some embodiments, the composition is biodegradable. In some embodiments, the composition is biodegradable within six months. In some embodiments, the composition is configured as a film.

An additional aspect of the disclosure provides a method. The method comprises: (a) providing a fibrous material, a polysaccharide, a gelatinization agent and a plasticizer to a reactor, thereby obtaining a mixture in the reactor; and (b) in the reactor, heating material of the mixture at temperature(s) sufficient to transition the material through a plurality of material transition phases and thereby obtain a product, where the heating is performed for less than or equal to 30 minutes.

In some embodiments, the method further comprises, in (a), providing a slurry comprising the fibrous material and the gelatinization agent to the reactor. In some embodiments, the gelatinization agent comprises water. In some embodiments, the method further comprises generating the slurry by subjecting a precursor fibrous material and the gelatinization agent to pulping. In some embodiments, in (a), the fibrous material, the polysaccharide, the plasticizer and the gelatinization agent are provided to the reactor simultaneously. In some embodiments, in (a), at least one of the fibrous material, the polysaccharide, the plasticizer and the gelatinization agent is provided separately to the reactor.

In some embodiments, the plurality of material transition phases comprises a gelatinization phase, a plastification phase and a fibrous bonding phase. In some embodiments, the method further comprises in (b), applying a shear stress to the mixture. In some embodiments, the temperature(s) range from about 50° C. to about 400° C. In some embodiments, the heating is performed for less than or equal to 15 min.

In some embodiments, (b) comprises polymerization of one or more materials of the mixture. In some embodiments, the method further comprises after (b), subjecting the product to extrusion to obtain an extruded product. In some embodiments, the method further comprises

after extrusion, form-factoring the extruded product to obtain a form-factored product. In some embodiments, the form-factored product is configured as a film. In some embodiments, the method further comprises subjecting the form-factored product to drying and/or thickening.

In some embodiments, in (a), the fibrous material and the plasticizer are provided to the reactor at a weight-percent ratio of fibrous material to plasticizer from about 0.01 to about 10. In some embodiments, in (a), the fibrous material and the polysaccharide are provided to the reactor at a weight-percent ratio of fibrous material to polysaccharide from about 0.01 to about 10. In some embodiments, in (a), the polysaccharide and the gelatinization agent are provided to the reactor at a weight-percent ratio of polysaccharide to gelatinization agent from about 0.0001 to about 1. In some embodiments, in (a), the fibrous material and the gelatinization agent are provided to the reactor at a weight-percent ratio of fibrous material to gelatinization agent from about 0.0001 to about 1.

In some embodiments, the fibrous material is cellulose or derivative thereof. In some embodiments, the fibrous material is a natural fiber. In some embodiments, the polysaccharide is starch or derivative thereof. In some embodiments, the plasticizer is selected from the group consisting of glycerol, maltose, urea, sorbitol, sucrose, fructose, glucose, formamide, citric acid, amino acid, malic acid, ethylenebisformamide, buriti oil, polyethylene glycol, acetamide, ethanolamine, isoleucine, asparagine, ethanolamine, polyoils, lecithin, monoglycerides, propylene glycol, diethyleneoxide glycol, triethyleneoxide glycol and poliethyleneoxide glycol. In some embodiments, the plasticizer is glycerol or derivative thereof. In some embodiments, the method further comprises, in (a), providing acetic acid to the reactor and where the mixture comprises the acetic acid. In some embodiments, the product comprises a dynamic viscosity of about 100 centipoise (cP) to about 5,000,000 cP.

An additional aspect of the disclosure provides a method. The method comprises: (a) providing a fibrous material, a polysaccharide, a gelatinization agent, and a plasticizer to a reactor, thereby obtaining a mixture in the reactor; and (b) in the reactor, heating material of the mixture at temperature(s) sufficient to transition the material through a plurality of material transition phases and thereby obtain a product, where the product has a dynamic viscosity from about 100 centipoise (cP) to about 5,000,000 cP.

In some embodiments, the method further comprises, in (a), providing a slurry comprising the fibrous material and the gelatinization agent to the reactor. In some embodiments, the gelatinization agent comprises water. In some embodiments, the method further comprises generating the slurry by subjecting a precursor fibrous material and the gelatinization agent to pulping. In some embodiments, in (a), the fibrous material, the polysaccharide, the plasticizer and the gelatinization agent are provided to the reactor simultaneously. In some embodiments, in (a), at least one of the fibrous material, the polysaccharide, the plasticizer and the gelatinization agent is provided separately to the reactor. In some embodiments, the plurality of material transition phases comprises a gelatinization phase, a plastification phase and a fibrous bonding phase. In some embodiments, the method further comprises, in (b), applying a shear stress to the mixture.

In some embodiments, (b) comprises polymerization of one or more materials of the mixture. In some embodiments, the method further comprises, after (b), subjecting the product to extrusion to obtain an extruded product. In some embodiments, the method further comprises

after extrusion, form-factoring the extruded product to obtain a form-factored product. In some embodiments, the form-factored product is configured as a film. In some embodiments, the method further comprises subjecting the form-factored product to drying. In some embodiments, the method further comprises subjecting the form-factored product to thickening.

In some embodiments, in (a), the fibrous material and the plasticizer are provided to the reactor at a weight-percent ratio of fibrous material to plasticizer from about 0.01 to about 10. In some embodiments, in (a), the fibrous material and the polysaccharide are provided to the reactor at a weight-percent ratio of fibrous material to polysaccharide from about 0.01 to about 10. In some embodiments, in (a), the polysaccharide and the gelatinization agent are provided to the reactor at a weight-percent ratio of polysaccharide to gelatinization agent from about 0.0001 to about 1. In some embodiments, in (a), the fibrous material and the gelatinization agent are provided to the reactor at a weight-percent ratio of fibrous material to gelatinization agent from about 0.0001 to about 1.

In some embodiments, the fibrous material is cellulose or derivative thereof. In some embodiments, the fibrous material is a natural fiber. In some embodiments, the polysaccharide is starch or derivative thereof. In some embodiments, the plasticizer is selected from the group consisting of glycerol, maltose, urea, sorbitol, sucrose, fructose, glucose, formamide, citric acid, amino acid, malic acid, ethylenebisformamide, buriti oil, polyethylene glycol, acetamide, ethanolamine, isoleucine, asparagine, ethanolamine, polyoils, lecithin, monoglycerides, propylene glycol, diethyleneoxide glycol, triethyleneoxide glycol and poliethyleneoxide glycol. In some embodiments, the plasticizer is glycerol or derivative thereof.

In some embodiments, the method further comprises, in (a), providing acetic acid to the reactor and where the mixture comprises the acetic acid. In some embodiments, the temperature(s) is from about 50° C. to about 400° C.

An additional aspect of the disclosure provides a method. The method comprises: (a) providing a fibrous material, a polysaccharide, a gelatinization agent, and a plasticizer to a reactor, thereby obtaining a mixture in the reactor; (b) in the reactor, heating material of the mixture at temperature(s) sufficient to transition the material through a plurality of material transition phases and thereby obtain a product; (c) form-factoring the product or derivative thereof into a film; and (d) drying the film.

In some embodiments, the method further comprises, in (a), providing a slurry comprising the fibrous material and the gelatinization agent to the reactor. In some embodiments, the method further comprises generating the slurry by subjecting a precursor fibrous material and the gelatinization agent to pulping. In some embodiments, the gelatinization agent comprises water. In some embodiments, in (a), the fibrous material, the polysaccharide, the plasticizer and the gelatinization agent are provided to the reactor simultaneously. In some embodiments, in (a), at least one of the fibrous material, the polysaccharide, the plasticizer and the gelatinization agent is provided separately to the reactor.

In some embodiments, the plurality of material transition phases comprises a gelatinization phase, a plastification phase and a fibrous bonding phase. In some embodiments, the method further comprises, in (b), applying a shear stress to the mixture. In some embodiments, (b) comprises polymerization of one or more materials of the mixture. In some embodiments, the method further comprises, after (b), subjecting the product to extrusion to obtain an extruded product. In some embodiments, the method further comprises form-factoring the extruded product to obtain the film.

In some embodiments, the method further comprises subjecting the film to thickening. In some embodiments, in (a), the fibrous material and the plasticizer are provided to the reactor at a weight-percent ratio of fibrous material to plasticizer from about 0.01 to about 10. In some embodiments, in (a), the fibrous material and the polysaccharide are provided to the reactor at a weight-percent ratio of fibrous material to polysaccharide from about 0.01 to about 10. In some embodiments, in (a), the polysaccharide and the gelatinization agent are provided to the reactor at a weight-percent ratio of polysaccharide to gelatinization agent from about 0.0001 to about 1. In some embodiments, in (a), the fibrous material and the gelatinization agent are provided to the reactor at a weight-percent ratio of fibrous material to gelatinization agent from about 0.0001 to about 1. In some embodiments, the fibrous material is cellulose or derivative thereof. In some embodiments, the fibrous material is a natural fiber. In some embodiments, the polysaccharide is starch or derivative thereof.

In some embodiments, the plasticizer is selected from the group consisting of glycerol, maltose, urea, sorbitol, sucrose, fructose, glucose, formamide, citric acid, amino acid, malic acid, ethylenebisformamide, buriti oil, polyethylene glycol, acetamide, ethanolamine, isoleucine, asparagine, ethanolamine, polyoils, lecithin, monoglycerides, propylene glycol, diethyleneoxide glycol, triethyleneoxide glycol and poliethyleneoxide glycol. In some embodiments, the plasticizer is glycerol or derivative thereof. In some embodiments, the method further comprises, in (a), providing acetic acid to the reactor and wherein the mixture comprises the acetic acid. In some embodiments, the temperature(s) is from about 50° C. to about 400° C.

An additional aspect of the disclosure provides a method. The method comprises: (a) dulping, to de-fiber natural fibers; (b) dolymerizing fibers to produce a filmogenic non-newtonian fluid; (c) distributing the non-newtonian fluid into a film; and drying, thereby dehydrating the film.

In some embodiments, the method further comprises mixing Cellulose:Starch:Glycerol:Water in a ratio of 1:1.13:1.13:15.09 to 1:6:6:2127.66 in and also 1:17.11:17.11:227.97. In some embodiments, polymerized mixture has not undergone chemical reaction, only physical combination. In some embodiments, polymerizing comprises heating at a temperature ranging from 100-250° C. for a time period of 5-30 minutes. In some embodiments, polymerization occurs until material reaches a viscosity of about 1180 cP. In some embodiments, biomass material is extruded in a conveyor belt through an extruder die.

In some embodiments, material is embodied into the film through pressure applied by distributing sheets between the material and the conveyor belt. In some embodiments, the distributing sheets comprise rigid and smooth elements. In some embodiments, the smooth element is made from silicone or teflon. In some embodiments, material is dried through forced convection air. In some embodiments, the forced convection air is heated by a heating element to a temperature between 40 to 80° C., at a distance of 1 to 50 mm. In some embodiments,

a heat plate applies heat from inside a conveyor belt to dry an inner layer of the film.

In some embodiments, the heat plate applies heat at a temperature that ranges from 70 to 105° C. In some embodiments, the method further comprises an additional drying operation, wherein the additional drying operation comprises turning material to dry an inner layer of the material. In some embodiments, material is turned by a vacuum conveyor belt. In some embodiments, the vacuum conveyor belt comprises felt. In some embodiments, material is turned by a robotic arm. In some embodiments, material is turned by a gantry system. In some embodiments, drying utilizes an oven conveyor belt.

In some embodiments, the method further comprises thickening to provide a uniform thickness to the film. In some embodiments, thickening is achieved with abrasion resistant rolls. In some embodiments, the abrasion resistant rolls are made of silicone, PVC or Teflon.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 provides an example workflow for generating an example customized product;

FIG. 2 provides an example lifecycle of an example product described herein;

FIGS. 3A-3C provide photographs of example products;

FIGS. 4A-4H provide examples of chemical structures described herein;

FIG. 5 provides material components of an example composition;

FIGS. 6A-6E provide examples of variation in material mechanical properties;

FIG. 7 provides photographs of example material biodegradability;

FIGS. 8A-8D material components of example compositions;

FIGS. 9A and 9B provides example production methods;

FIGS. 10A-10D provide schematic examples of stages of production;

FIG. 11 provides a schematic example of a production process;

FIGS. 12A-12C graphically provides examples of dynamic viscosity with example processing parameters;

FIG. 13 conceptually provides example modes and scales of production;

FIG. 14 conceptually provides an example production method;

FIGS. 15A-15C provide example production methods;

FIGS. 16A and 16B provide example production methods;

FIGS. 17A and 17B provide example production methods;

FIG. 18 shows a computer control system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Recognized herein is an ongoing need for traditional plastic alternatives. The disclosure provides biological compositions that can function as alternatives for traditional plastics. The compositions can include various components, including one or more of fibrous materials, polysaccharides, plasticizers and gelatinization agents. Such compositions can have mechanical properties that meet or exceed threshold values for useful implantation in a variety of contexts. Such compositions can also be shaped into several form-factors depending upon the predetermined design. The disclosure also provides methods for making such compositions and methods for customized formulations that may be desirable. Methods can include various processes including one or more of pulping processes, polymerization processes, drying processes and form factoring processes.

### Compositions

An aspect of the disclosure provides a composition, comprising one or more of: a fibrous material; a polysaccharide; a plasticizer and a gelatinization agent. The composition can include fibrous material and plasticizer at a weight-percent ratio of fibrous material to plasticizer at a variety of different ratios. In some examples, the weight-percent ratio of fibrous material to plasticizer is from about 0.01 to about 10. In some examples, the weight-percent ratio of fibrous material to plasticizer is from about 0.01 to about 5, from about 0.01 to about 1, from about 0.01 to about 0.1, from about 0.01 to about 0.05, from about 0.03 to about 0.05, from about 0.03 to about 1, from about 0.03 to about 5, from about 0.03 to about 10, from about 0.05 to about 10, from about 0.05 to about 1, from about 1 to about 10, from about 2 to about 10, from 5 to about 10.

In some examples, the weight-percent ratio of fibrous material to plasticizer is at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, or more. In some examples, the weight-percent ratio of fibrous material to plasticizer is at most 10, at most 9, at most 8, at most 7, at most 6, at most 5, at most 4, at most 3, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most at 0.06, at most at 0.05, at most 0.04, at most 0.03, at most 0.02, at most 0.01, or less.

In some examples, the weight-percent ratio of fibrous material to polysaccharide is from about 0.01 to about 10. In some examples, the weight-percent ratio of fibrous material to polysaccharide is from about 0.01 to about 5, from about 0.01 to about 1, from about 0.01 to about 0.1, from about 0.01 to about 0.05, from about 0.03 to about 0.05, from about 0.03 to about 1, from about 0.03 to about 5, from about 0.03 to about 10, from about 0.05 to about 10, from about 0.05 to about 1, from about 1 to about 10, from about 2 to about 10, from 5 to about 10.

In some examples, the weight-percent ratio of fibrous material to polysaccharide is at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, or more. In some examples, the weight-percent ratio of fibrous material to polysaccharide is at most 10, at most 9, at most 8, at most 7, at most 6, at most 5, at most 4, at most 3, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most at 0.06, at most at 0.05, at most 0.04, at most 0.03, at most 0.02, at most 0.01, or less.

In some examples, the weight-percent ratio of polysaccharide to plasticizer is from about 0.01 to about 20. In some examples, the weight-percent ratio of polysaccharide to plasticizer is from about 0.01 to about 5, from about 0.01 to about 1, from about 0.01 to about 0.1, from about 0.01 to about 0.05, from about 0.03 to about 0.05, from about 0.03 to about 0.8, from about 0.03 to about 1, from about 0.03 to about 5, from about 0.03 to about 10, from about 0.05 to about 10, from about 0.05 to about 1, from about 1 to about 10, from about 2 to about 10, from about 3 to about 10, from about 4 to about 10, from about from 5 to about 10, from about 6 to about 10, from about 7 to about 10, from about 8 to about 10, from about 9 to about 10.

In some examples, the weight-percent ratio of polysaccharide to plasticizer is at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 12, at least 14, at least 16, at least 18, at least 20 or more. In some examples, the weight-percent ratio of polysaccharide to plasticizer is at most 20, at most 18, at most 16, at most 14, at most 12, at most 10, at most 9, at most 8, at most 7, at most 6, at most 5, at most 4, at most 3, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most at 0.06, at most at 0.05, at most 0.04, at most 0.03, at most 0.02, at most 0.01, or less.

The composition can comprise any suitable fibrous material. In some examples, the fibrous material comprises cellulose. Winceyette Fibers, liganocelluose, nano cellulose, straw (e.g., Barley, Canola, Oat, Wheat, etc.), chitin, chitosan, silk, collagen, keratin, wool, hair, sinew, catgut, angora, mohair, cellulose nano crystals (CNC). In some examples, the fibrous material is cellulose or a derivative thereof. In some cases, the cellulose is wood cellulose. In some examples, the cellulose is anhydrocellulose. In some examples, the cellulose is a natural fiber. Moreover, the fibrous material can be obtained and/or derived from any suitable source, with non-limiting examples that include food, animal fur, plant matter, tree matter, seaweed, organic waste, corrugated cardboard, recycled paper, recycled tissue paper, recycled cardboard, tissue paper, recycled wood fibers, pulp, and Virgin fibers. Furthermore, the fibrous material can be a polymeric species. In cases the fibrous materials are recycled fibers. Individual subunits of such a polymeric species can be linked together via glycosidic bonds.

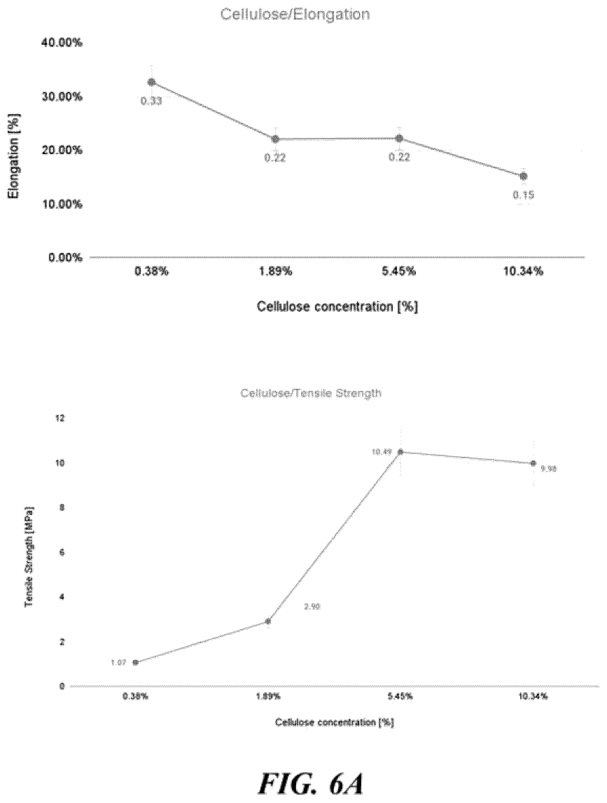

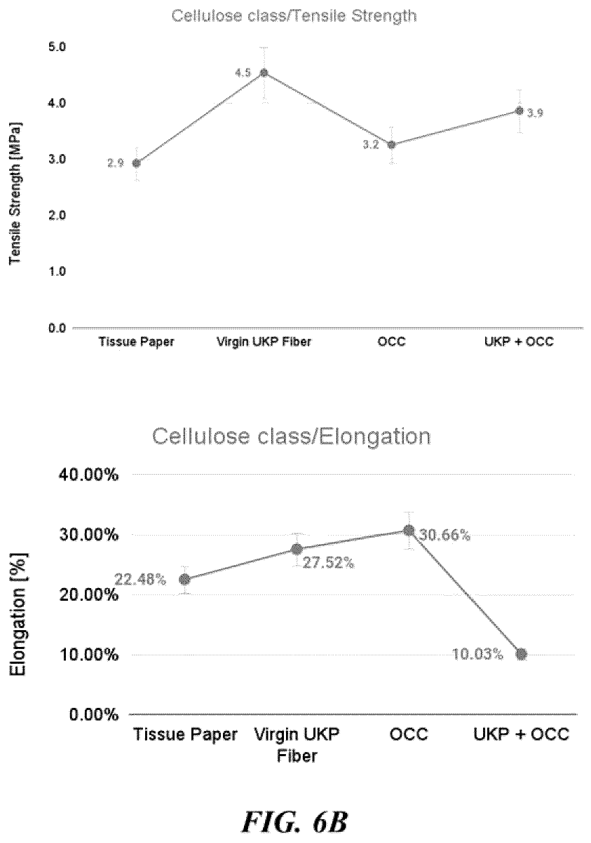

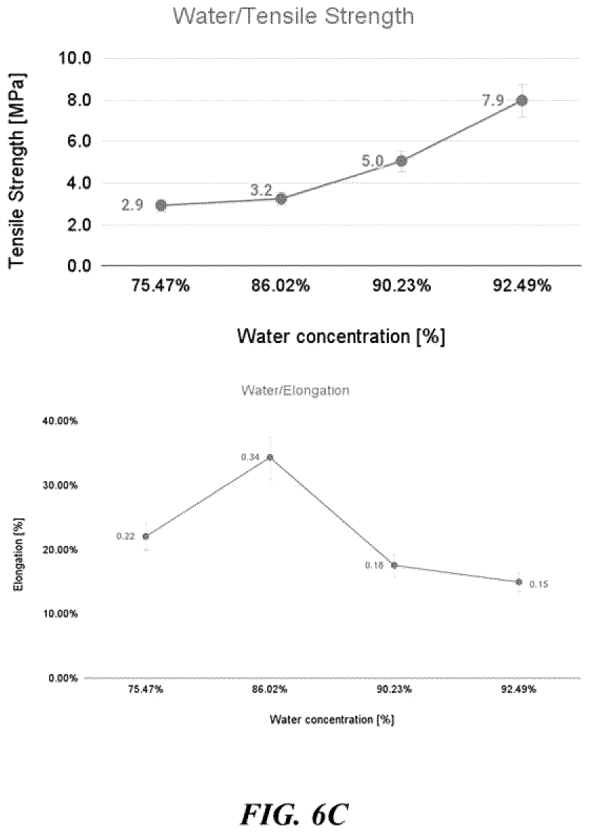

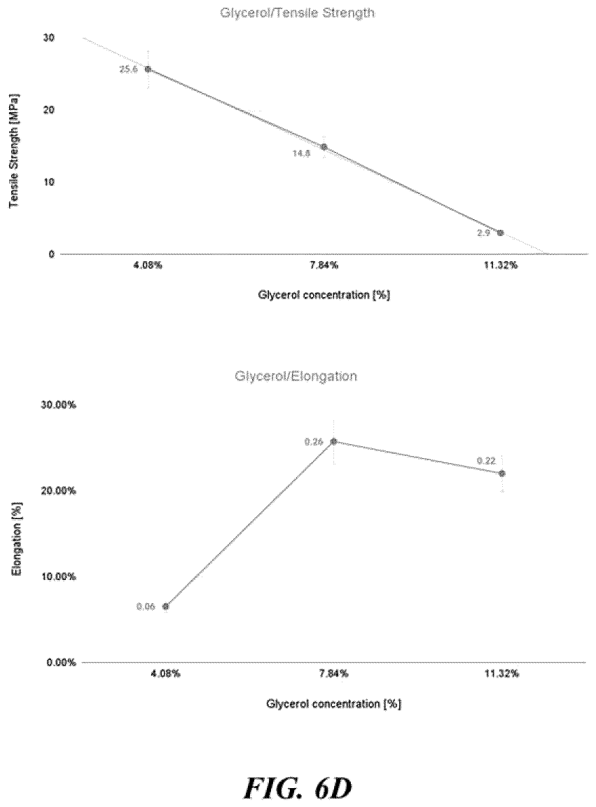

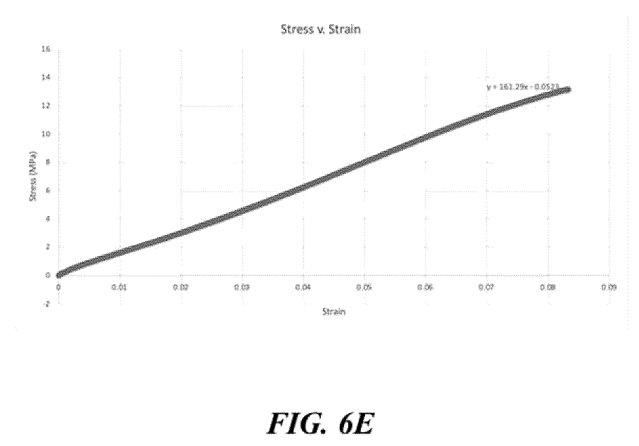

The source and fraction of fibrous material can impact the material properties of the composition. For example, the lignin and/or fiber length content in fibrous material can impact tensile strength and material elasticity. An example of such effect is graphically depicted in FIG. 6B. As shown in FIG. 6B, sources of different fibrous material (cellulose in FIG. 6B) yield different material tensile strength, elongation and other properties as well. Higher lignin or longer fiber length content materials (unbleached kraft pulp (UKP)-30% lignin content) results in materials with differing tensile strength and elongation than old, corrugated cardboard (OCC) (<15% lignin) and tissue paper (short fiber-length). In another example, the fraction of fibrous material in the composition can also impact elongation and tensile strength. An example of such effect is graphically depicted in FIG. 6A. As shown in FIG. 6A, increasing cellulose fraction in a material generally increases tensile strength and reduces elongation.

The composition can comprise any suitable polysaccharide. In some examples, the polysaccharide is a form of starch or derivative of a form of starch. Non-limiting examples of starch and starch derivatives include pea starch, potato starch, moonbeam starch, corn starch, tapioca starch, arrowroot starch, rice starch, wheat starch, captured carbon based starch and starch from tree matter.

Bonding can form between the fibrous material and polysaccharide. Bonding between these elements can occur as a result of the chemical affinity between the two materials. Fibrous material can form a rigid network with the polysaccharide, such as, for example, via the interaction of hydrogen bonds (e.g., via interaction of hydroxyl moieties of both species). Such interaction between the two elements can limit movement, resulting in a higher material strength and stiffness, including during production (e.g., the ability to withstand forces of retrogradation). Such bonding properties can broaden the useful ranges of other compositional components, including, for example, plasticizers.

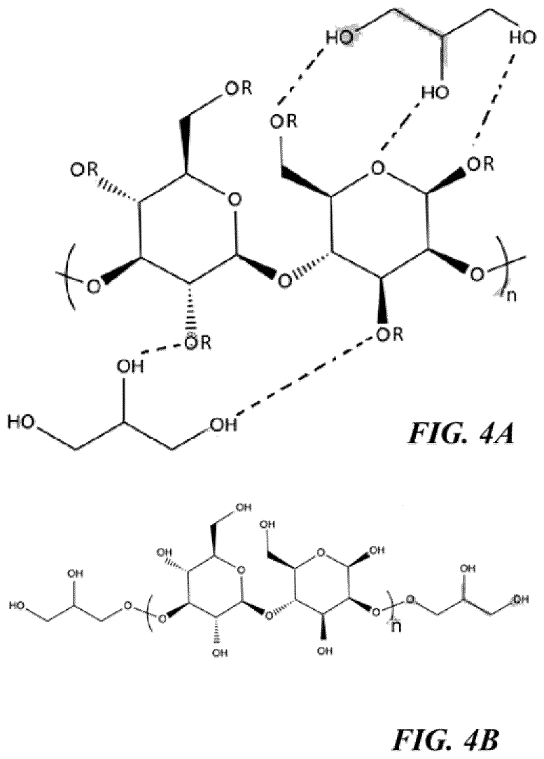

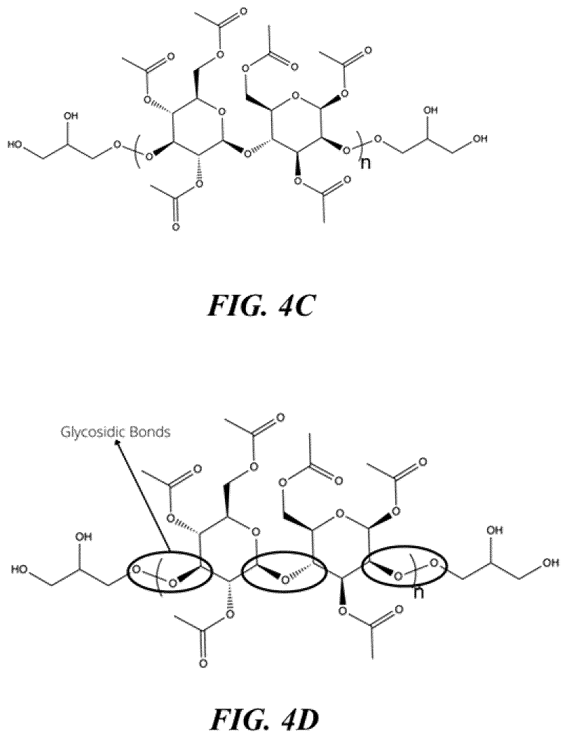

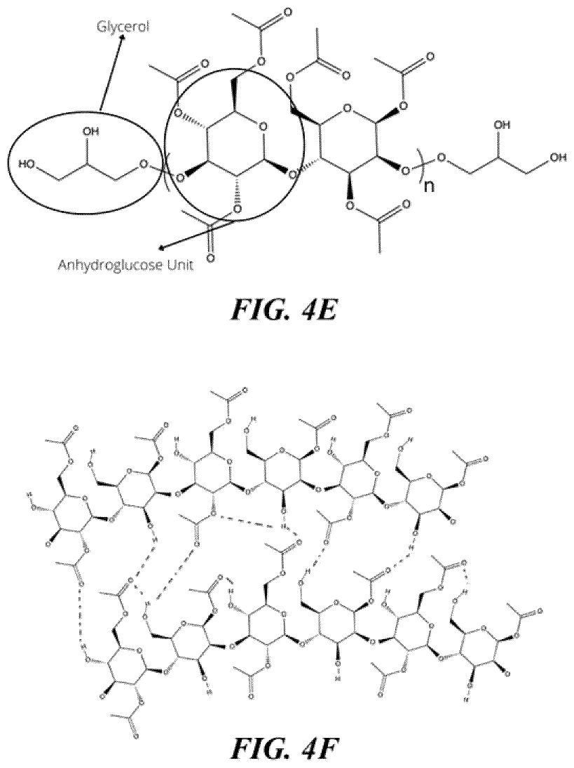

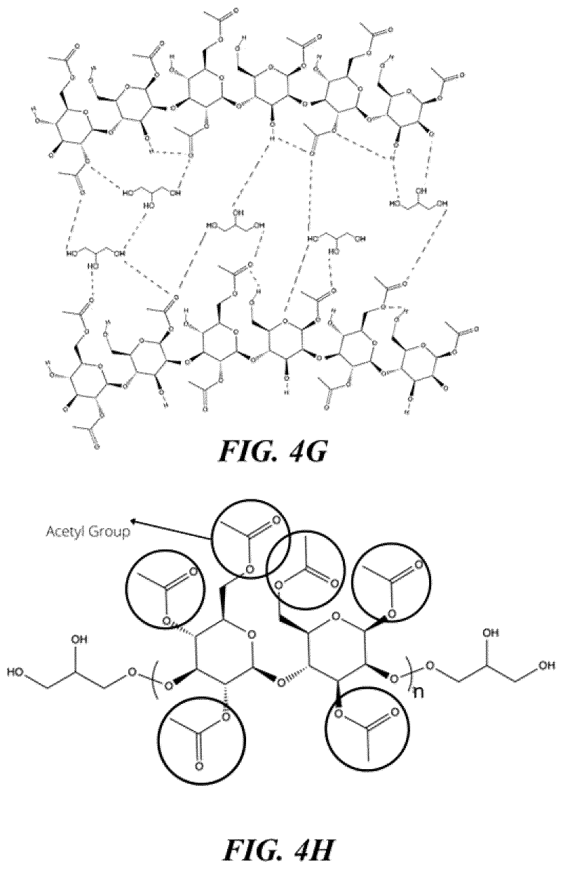

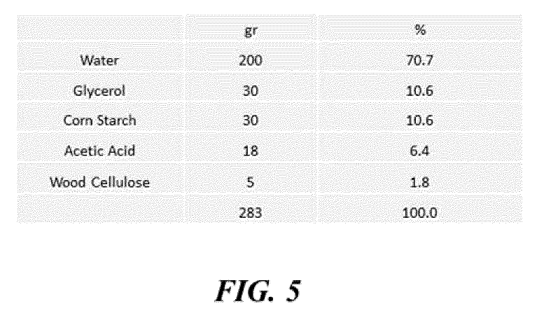

The composition can comprise any suitable plasticizer. In some examples, the plasticizer is glycerol, maltose, urea, sorbitol, sucrose, fructose, glucose, formamide, citric acid, amino acid, malic acid, ethylenebisformamide, buriti oil, polyethylene glycol, acetamide, ethanolamine, isoleucine, asparagine, ethanolamine, polyoils, lecithin, monoglycerides, propylene glycol, diethyleneoxide glycol, triethyleneoxide glycol and poliethyleneoxide glycol. In some cases, the plasticizer is glycerol or derivative thereof. In some cases, the plasticizer is coupled to the fibrous material via a non-covalent linkage. Coupling can be via a non-covalent linkage (e.g., a hydrogen bond) or a covalent linkage (e.g., a glycosidic bond). In some examples, the fibrous material is chemically networked with the polysaccharide via the plasticizer. An example of such a chemical network is shown structurally in FIG. 4G. An example of such a chemical network without plasticizer is shown in FIG. 4F.

Plasticizer can reduce interactive forces between chains of fibrous material or polysaccharide and/or reduce interactive forces between fibrous material and polysaccharide. For example, reduction in interactive forces between polysaccharide (e.g., starch) units can reduce crystallinity. Reduction of interactive forces (e.g., hydrogen bonds) can yield a reduction in stiffness/rigidity and/or density of the composition. In turn, reduced stiffness/rigidity enhances elasticity and can reduce a material's retrogradation. Reduced stiffness/rigidity can provide higher elongation between material constituents which can aid in shaping the product (e.g., in the form of a sheet/film). This is structurally indicated in FIG. 4F where plasticizer widens the distance between material chains, whereas, in absence of plasticizer, material chains are tighter together as shown in FIG. 4G. An example of the effect of plasticizer fraction on composition properties is graphically depicted in FIG. 6D. As shown in FIG. 6D, material tensile strength generally decreases with increasing glycerol fraction, whereas elongation varies with increasing glycerol fraction.

In some examples, the composition may comprise no more than about 50 weight percent plasticizer, no more than about 40 weight percent plasticizer, no more than about 30 weight percent plasticizer, no more than about 25 weight percent plasticizer, no more than about 20 weight percent plasticizer, no more than about 15 weight percent plasticizer, no more than about 10 weight percent plasticizer, no more than about 8 weight percent plasticizer, no more than about 6 weight percent plasticizer, no more than about 4 weight percent plasticizer, or no more than about 2 weight percent plasticizer. Reduced amounts of plasticizer can improve material strength and can also lower costs as plasticizers can be expensive.

In some cases, the composition comprises the polymeric chemical structure shown in FIG. 4A, FIG. 4B or 4C. With respect to FIG. 4A, “R” can be, for example, an acetyl group (e.g., from treatment with acetic acid) or can be hydrogen. With respect to FIGS. 4A-4C, n can be any suitable number of polymeric units. In some examples, n is from about 1 to about 2000, from about 1 to about 1500, from about 1 to about 1000, from about 1 to about 900, from about 1 to about 800, from about 1 to about 700, from about 1 to about 600, from about 1 to about 500, from about 1 to about 450, from about 1 to about 400, from about 1 to about 350, from about 1 to about 300, from about 1 to about 250, from about 1 to about 200, from about 1 to about 150, from about 1 to 1000, from about 50 to about 500, from about 50 to about 1000, from about 100 to about 500 or from 100 to about 1000.

In some examples, n is greater than or equal to 3, greater than or equal to 10, greater than or equal to 25, greater than or equal to 50, greater than or equal to 75, greater than or equal to 100, greater than or equal to 125, greater than or equal to 150, greater than or equal to 175, greater than or equal to 200, greater than or equal to 225, greater than or equal to 250, greater than or equal to 300, greater than or equal to 350, greater than or equal to 400, greater than or equal to 450, greater than or equal to 500, or more. In some examples, n is less than or equal to 500, less than or equal to 450, less than or equal to 400, less than or equal to 350, less than or equal to 300, less than or equal to 250, less than or equal to 200, less than or equal to 175, less than or equal to 150, less than or equal to 125, less than or equal to 100, less than or equal to 75, less than or equal to 50, less than or equal to 25, less than or equal to 10, less than or equal to 5, or less. FIG. 4D highlights glycosidic bonds of the structure shown in FIG. 4C. FIG. 4E highlights glycerol on anhydroglucose units of the structure shown in FIG. 4C. FIG. 4H highlights acetyl groups of FIG. 4C.

The composition can also comprise a gelatinization agent such as, for example, water. A gelatinization agent can break polysaccharide (e.g., starch) hydrogen bridges, which can transition the polysaccharide into a disordered structure. Heat can aid in the process. The loss of crystalline order can lead to expansion of polysaccharide granules and an increase in polysaccharide solubility. These properties can improve polysaccharide interaction with other components, including fibrous material and plasticizer. Where water is the gelatinization agent, it can also function as a plasticizer, which can reduce stiffness/rigidity and enhance the material's elongation.

Material properties can depend on the fraction of gelatinization agent. An example of such effect is shown graphically in FIG. 6C. As shown in FIG. 6C, tensile strength increases with increasing water fraction in the material and elongation varies with increasing water fraction.

In some examples, the weight-percent ratio of polysaccharide to gelatinization agent is from about 0.0001 to about 1. In some examples, the weight-percent ratio of polysaccharide to gelatinization is from about 0.0001 to about 0.5, from about 0.0001 to about 0.1, from about 0.001 to about 1, from about 0.001 to about 0.8, from about 0.001 to about 0.6, from about 0.001 to about 0.4, from about 0.001 to about 0.4, from about 0.001 to about 0.2, from about 0.001 to about 0.08, from about 0.001 to about 0.06, from about 0.001 to about 0.06, from about 0.001 to about 0.04, from about 0.001 to about 0.02, from about 0.0001 to about 0.0008, from about 0.0001 to about 0.0006, or from about 0.0001 to about 0.0004.

In some examples, the weight-percent ratio of polysaccharide to gelatinization agent is at least 0.0001, at least 0.0002, at least 0.0003, at least 0.0004, at least 0.0005, at least 0.0006, at least 0.0007, at least 0.0008, at least 0.0009, at least 0.001, at least 0.002, at least 0.003, at least 0.004, at least 0.005, at least 0.006, at least 0.007, at least 0.008, at least 0.009, at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1 or more. In some examples, the weight-percent ratio polysaccharide to gelatinization agent is at least is at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most 0.06, at most 0.05, at most 0.04, at most 0.03, at most 0.02, at most 0.01, at most 0.009, at most 0.008, at most 0.007, at most at 0.006, at most 0.005, at most 0.004, at most 0.003, at most 0.002, at most 0.001, at most 0.09, at most 0.08, at most 0.07, at most 0.06, at most 0.05, at most 0.04, at most 0.03, at most 0.02, at most 0.01, at most 0.0009, at most 0.0008, at most 0.0007, at most at 0.0006, at most 0.0005, at most 0.0004, at most 0.0003, at most 0.0002, at most 0.0001, or less.

In some examples, the weight-percent ratio of fibrous material to gelatinization agent is from about 0.0001 to about 1. In some examples, the weight-percent ratio of fibrous material to gelatinization is from about 0.0001 to about 0.5, from about 0.0001 to about 0.1, from about 0.001 to about 1, from about 0.001 to about 0.8, from about 0.001 to about 0.6, from about 0.001 to about 0.4, from about 0.001 to about 0.4, from about 0.001 to about 0.2, from about 0.001 to about 0.08, from about 0.001 to about 0.06, from about 0.001 to about 0.06, from about 0.001 to about 0.04, from about 0.001 to about 0.02, from about 0.0001 to about 0.0008, from about 0.0001 to about 0.0006, or from about 0.0001 to about 0.0004.

In some examples, the weight-percent ratio of fibrous material to gelatinization agent is at least 0.0001, at least 0.0002, at least 0.0003, at least 0.0004, at least 0.0005, at least 0.0006, at least 0.0007, at least 0.0008, at least 0.0009, at least 0.001, at least 0.002, at least 0.003, at least 0.004, at least 0.005, at least 0.006, at least 0.007, at least 0.008, at least 0.009, at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1 or more. In some examples, the weight-percent ratio fibrous material to gelatinization agent is at least is at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most 0.06, at most 0.05, at most 0.04, at most 0.03, at most 0.02, at most 0.01, at most 0.009, at most 0.008, at most 0.007, at most at 0.006, at most 0.005, at most 0.004, at most 0.003, at most 0.002, at most 0.001, at most 0.09, at most 0.08, at most 0.07, at most 0.06, at most 0.05, at most 0.04, at most 0.03, at most 0.02, at most 0.01, at most 0.0009, at most 0.0008, at most 0.0007, at most at 0.0006, at most 0.0005, at most 0.0004, at most 0.0003, at most 0.0002, at most 0.0001, or less.

In some cases, the composition can comprise acetic acid. Acetic acid can transform one or more hydrogen groups of a fibrous material, polysaccharide and/or plasticizer described herein to acetyl groups. Such transformation can be achieved via esterification as described elsewhere herein. In an example, the structure shown in FIG. 4C shows acetylated anhydroglucose of polysaccharide (e.g., starch). Acetyl groups can modify the physicochemical and functional properties of a composition, such as, for example, by reducing hydrophilic properties of one or more of its components (e.g., starch). An acetyl group is bulkier than a hydroxyl group, and as such material chains can undergo structural rearrangement upon acetylation due to, for example, steric hindrance causing repulsion between chains. As a result of repulsion, material chains can be less likely to form linkages (e.g., hydrogen bonds) and reassociate resulting in a material less prone to retrogradation. Acetylation can also improve composition shelf life compared to other available materials and can also enable degradability, water permeability and microorganism action on the material.

The composition can comprise varied amount of acetic acid. In some cases, the composition comprises a weight-percent ratio of acetic acid to fibrous material from about 0.01 to about 50. In some cases, the composition comprises a weight-percent ratio of acetic acid to fibrous material from about 0.01 to about 25, from about 0.01 to about 10, from about 0.1 to about 45, from about 0.1 to about 40, from about 0.1 to about 35, from about 0.1 to about 30, from about 0.1 to about 25, from about 0.1 to about 20, from about 0.1 to about 15, from about 0.1 to about 10, from about 0.1 to about 5 or from about 0.1 to about 1.

In some cases, the composition comprises a weight-percent ratio of acetic acid to fibrous material of at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 15, at least 20, at least 25, at least 30, at least 35, at least 40, at least 45, at least 50, or more.

In some cases, the composition comprises a weight-percent ratio of acetic acid to fibrous material of at most 50, at most 45, at most 40, at most 35, at most 30, at most 25, at most 20, at most 15, at most 10, at most 9, at most 8, at most 7, at most 6, at most 5, at most 4, at most 3, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most 0.06, at most 0.05, at most 0.04, at most 0.03, at most 0.02, at most 0.01, or less.

In some cases, the composition comprises a weight-percent ratio of acetic acid to polysaccharide from about 0.001 to about 20. In some cases, the composition comprises a weight-percent ratio of acetic acid to polysaccharide from about 0.001 to about 10, from about 0.001 to about 5, from about 0.001 to about 2, from about 0.001 to about 1, from about 0.01 to about 10, from about 0.01 to about 5, from about 0.01 to about 2 or from about 0.01 to about 1.

In some cases, the composition comprises a weight-percent ratio of acetic acid to polysaccharide of at least 0.001, at least 0.002, at least 0.003, at least 0.004, at least 0.005, at least 0.006, at least 0.007, at least 0.008, at least 0.009, at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 5, at least 10 at least 20 or more.

In some cases, the composition comprises a weight-percent ratio of acetic acid to polysaccharide of at most 20, at most 10, at most 5, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most 0.06, at most 0.05, at most 0.04, at most 0.03, at most 0.02, at most 0.01, at most 0.009, at most 0.008, at most 0.007, at most 0.006, at most 0.005, at most 0.004, at most 0.003, at most 0.002, at most 0.001, or less.

In some cases, the composition comprises a weight-percent ratio of acetic acid to gelatinization agent from about 0.0001 to about 1. In some cases, the composition comprises a weight-percent ratio of acetic acid to gelatinization agent from about 0.001 to about 1, from about 0.001 to about 0.5, from about 0.001 to about 0.1, from about 0.001 to about 0.05, from about 0.001 to about 0.01 or from about 0.001 to about 0.005.

In some cases, the composition comprises a weight-percent ratio of acetic acid to gelatinization agent of at least 0.0001, at least 0.0002, at least 0.0003, at least 0.0004, at least 0.0005, at least 0.0006, at least 0.0007, at least 0.0008, at least 0.0009, at least 0.001, at least 0.002, at least 0.003, at least 0.004, at least 0.005, at least 0.006, at least 0.007, at least 0.008, at least 0.009, at least 0.01, at least 0.02, at least 0.03, at least 0.04, at least 0.05, at least 0.06, at least 0.07, at least 0.08, at least 0.09, at least 0.1, at least 0.2, at least 0.5, at least 1 at least 5 or more.

In some cases, the composition comprises a weight-percent ratio of acetic acid to gelatinization agent of at most 5, at most 1, at most 0.5, at most 0.2, at most 0.1, at most 0.09, at most 0.08, at most 0.07, at most 0.06, at most 0.05, at most 0.04, at most 0.03, at most 0.02, at most 0.01, at most 0.009, at most 0.008, at most 0.007, at most 0.006, at most 0.005, at most 0.004, at most 0.003, at most 0.002, at most 0.001, at most 0.0009, at most 0.0008, at most 0.0007, at most 0.0006, at most 0.0005, at most 0.0004, at most 0.0003, at most 0.0002, at most 0.0001, or less.

In some cases, the composition comprises a weight-percent ratio of acetic acid to plasticizer from about 0.01 to about 50. In some cases, the composition comprises a weight-percent ratio of acetic acid to plasticizer from about 0.01 to about 25, from about 0.01 to about 10, from about 0.1 to about 45, from about 0.1 to about 40, from about 0.1 to about 35, from about 0.1 to about 30, from about 0.1 to about 25, from about 0.1 to about 20, from about 0.1 to about 15, from about 0.1 to about 10, from about 0.1 to about 5 or from about 0.1 to about 1.

In some cases, the composition comprises a weight-percent ratio of acetic acid to plasticizer of at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 15, at least 20, at least 25, at least 30, at least 35, at least 40, at least 45, at least 50, or more.

In some cases, the composition comprises a weight-percent ratio of acetic acid to plasticizer of at most 50, at most 45, at most 40, at most 35, at most 30, at most 25, at most 20, at most 15, at most 10, at most 9, at most 8, at most 7, at most 6, at most 5, at most 4, at most 3, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most 0.06, at most 0.05, at most 0.04, at most 0.03, at most 0.02, at most 0.01, or less.

In addition to the components discussed above, the composition can comprise one or more of a nanoclay, a zeolite, a kaolinite, a bentonite, a halloysite, a montmorillonite, a smectite, an illite, a chlorite, a silicate, a gelatine, agar, nanocellulose, cellulose nanocrystals, cellulose fillers, cellulose acetate, maltose, urea, sorbitol, sucrose, fructose, glucose, formamide, citric acid, tartaric acid, amino acids, malic acid, ethylene bis formamide, buriti oil, polyethylene glycol, acetamide, ethanolamine, isoleucine, asparagine, ethanolamine, polyols, lecithin, monoglycerides, polysaccharides, propylene glycol, diethylene oxide glycol, trimethylene oxide glycol, trimethylene oxide glycol, chitosan, calcium carbonate, amylose, amylopectin or other materials.

The compositions described herein have a number of properties that include tensile strength, elasticity, modulus of elasticity, tear propagation, dynamic viscosity, puncture strength, and can also be biodegradable and/or water resistant. In some cases, one or more of the composition components is a renewable material. In some cases, the composition is recyclable and/or compostable.

The composition can comprise varied tensile strength depending, for example, on the specific components and ratio of components of the composition. In some examples, the tensile strength of a composition described herein is between about 0.1 megapascal (MPa) and about 200 MPa. In some examples, the tensile strength is between about 0.1 MPa to about 100 MPa, between about 1 MPa and about 150 MPa, between about 1 MPa and about 100 MPa, between about 1 MPa and about 90 MPa, between about 1 MPa and about 80 MPa, between about 1 MPa and about 70 MPa, between about 1 MPa and about 60 MPa, between about 1 MPa and about 50 MPa, between about 1 MPa and about 40 MPa, between about 1 MPa and about 30 MPa, between about 1 MPa and about 20 MPa, between about 1 MPa and about 10 MPa.

In some cases, the tensile strength of a composition described herein is at least about 0.1 MPa, at least about 0.5 MPa, at least about 1 MPa, at least about 10 MPa, at least about 20 MPa, at least about 30 MPa, at least about 40 MPa, at least about 50 MPa, at least about 60 MPa, at least about 70 MPa, at least about 80 MPa, at least about 90 MPa, at least about 100 MPa, at least about 110 MPa, at least about 120 MPa, at least about 130 MPa, at least about 140 MPa, at least about 150 MPa, at least about 160 MPa, at least about 170 MPa, at least about 180 MPa, at least about 190 MPa, at least about 200 MPa, or more.

The composition can comprise varied elasticity depending, for example, on the specific components and ratio of components of the composition. In some examples, the elasticity of a composition described herein is between about 0.10% and about 1000%. In some examples, the elasticity is between about 0.1% and about 700%, between about 0.1% and about 600%, between about 0.1% and about 500%, between about 0.1% and about 400%, between about 0.1% and about 300%, between about 0.1% and about 200%, between about 0.10% and about 100%, between about 0.10% and about 75%, between about 0.10% and about 50%, between about 0.1% and about 25%, between about 1% and about 100%, between about 1% and about 50%.

In some cases, the elasticity of a composition described herein is at least about 0.1%, at least about 0.5%, at least about 1%, at least about 5%, at least about 10%, at least about 20%, at least about 30%, at least about 40%, at least about 50%, at least about 60%, at least about 70%, at least about 80%, at least about 90%, at least about 100%, at least about 200%, at least about 300%, at least about 400%, at least about 500%, at least about 600%, at least about 700%, at least about 800%, at least about 900%, at least about 1000%, or more.

The composition can comprise varied modulus of elasticity depending, for example, on the specific components and ratio of components of the composition. In some examples, the modulus of elasticity of a composition described herein is between about 0.1 megapascal (MPa) and about 2000 MPa. In some examples, the modulus of elasticity is between about 1 MPa to about 1500 MPa, between about 1 MPa and about 1000 MPa, between about 1 MPa and about 900 MPa, between about 1 MPa and about 800 MPa, between about 1 MPa and about 700 MPa, between about 1 MPa and about 600 MPa, between about 1 MPa and about 500 MPa, between about 1 MPa and about 400 MPa, between about 1 MPa and about 300 MPa, between about 1 MPa and about 200 MPa, between about 1 MPa and about 100 MPa, between about 1 MPa and about 75 MPa, between about 1 MPa and about 75 MPa, between about 1 MPa and about 50 MPa, between about 1 MPa and about 25 MPa, between about 1 MPa and about 10 MPa, between about 1 MPa and about 5 MPa.

In some cases, the modulus of elasticity of a composition described herein is at least about 0.1 MPa, at least about 1 MPa, at least about 5 MPa, at least about 25 MPa, at least about 50 MPa, at least about 75 MPa, at least about 100 MPa, at least about 200 MPa, at least about 300 MPa, at least about 400 MPa, at least about 500 MPa, at least about 600 MPa, at least about 700 MPa, at least about 800 MPa, at least about 900 MPa, at least about 1000 MPa, at least about 1500 MPa, at least about 2000 MPa, or more. In some cases, the modulus of elasticity of a composition described herein is at most 2000 MPa, at most about 1500 MPa, at most about 1000 MPa, at most about 900 MPa, at most about 800 MPa, at most about 700 MPa, at most about 600 MPa, at most about 500 MPa, at most about 400 MPa, at most about 300 MPa, at most about 200 MPa, at most about 100 MPa, at most about 100 MPa, at most about 75 MPa, at most about 50 MPa, at most about 25 MPa, at most about 5 MPa, at most about 2 MPa, or less.

The composition can comprise varied tear propagation depending, for example, on the specific components and ratio of components of the composition. In some examples, the tear propagation of a composition described herein is between about 0.1 Newton (N) and about 50 N. In some examples, the tear propagation is between about 0.1 N to about 45 N, between about 0.1 N and about 40 N, between about 0.1 N and about 35 N, between about 0.1 N and about 30 N, between about 0.1 N and about 25 N, between about 0.1 N and about 20 N, between about 0.1 N and about 15 N, between about 0.1 N and about 10 N, between about 1 N and about 25 N, between about 1 N and about 20 N, between about 1 N and about 15 N, between about 1 N and about 10 N, between about 1 N and about 5 N.

In some cases, the tear propagation of a composition described herein is at least about 0.1 N, at least about 0.5 N, at least about 1 N, at least about 3 N, at least about 5 N, at least about 7 N, at least about 9 N, at least about 11 N, at least about 13 N, at least about 15 N, at least about 20 N, at least about 25 N, at least about 30 N, at least about 35 N, at least about 40 N, at least about 50 N or more. In some cases, the tear propagation of a composition described herein is at most 50 N, at most about 45 N, at most about 40 N, at most about 35 N, at most about 30 N, at most about 25 N, at most about 20 N, at most about 15 N, at most about 13 N, at most about 11 N, at most about 9 N, at most about 7 N, at most about 5 N, at most about 3 N, at most about 1 N, at most about 0.5 N, at most about 0.1 N, or less.

The composition can comprise varied dynamic viscosity depending, for example, on the specific components and ratio of components of the composition. In some examples, the dynamic viscosity of a composition described herein is between about 100 centipoise (cP) and about 5,000,000 cP. In some examples, the dynamic viscosity is between about 1000 cP to about 4,000,000 cP, between about 1000 cP and about 3,000,000 cP, between about 1000 cP and about 2,000,000 cP, between about 1000 cP and about 1,00,000 cP.

In some cases, the dynamic viscosity of a composition described herein is at least about 100 cP, at least about 500 cP, at least about 1000 cP, at least about 5000 cP, at least about 10000 cP, at least about 50000 cP, at least about 100000 cP, at least about 500000 cP, at least about 1000000 cP, at least about 2000000 cP, at least about 3000000 cP, at least about 4000000 cP, at least about 5000000 cP, or more. In some cases, the dynamic viscosity of a composition described herein is at most 5000000 cP, at most about 4000000 cP, at most about 3000000 cP, at most about 2000000 cP, at most about 1000000 cP, at most about 500000 cP, at most about 100000 cP, at most about 50000 cP, at most about 10000 cP, at most about 5000 cP, at most about 1000 cP, at most about 500 cP, at most about 100 cP, or less.

The composition can comprise varied puncture strength depending, for example, on the specific components and ratio of components of the composition. In some examples, the puncture strength of a composition described herein is between about 1 Newton (N) and about 75 N. In some examples, the puncture strength is between about 1 N to about 70 N, between about 1 N and about 65 N, between about 1 N and about 60 N, between about 1 N and about 55 N, between about 1 N and about 50 N, between about 1 N and about 45 N, between about 1 N and about 40 N, between about 1 N and about 35 N, between about 1 N and about 30 N, between about 1 N and about 25 N, between about 1 N and about 20 N, between about 1 N and about 15 N, between about 10 N and about 30 N.

In some cases, the puncture strength of a composition described herein is at least about 1 N, at least about 3 N, at least about 5 N, at least about 7 N, at least about 10 N, at least about 12 N, at least about 15 N, at least about 20 N, at least about 25 N, at least about 30 N, at least about 35 N, at least about 40 N, at least about 45 N, at least about 50 N, at least about 55 N, at least about 60 N, at least about 65 N, at least about 70 N, at least about 75 N or more. In some cases, the puncture strength of a composition described herein is at most 75 N, at most about 70 N, at most about 65 N, at most about 60 N, at most about 55 N, at most about 50 N, at most about 45 N, at most about 40 N, at most about 35 N, at most about 30 N, at most about 25 N, at most about 20 N, at most about 15 N, at most about 12 N, at most about 10 N, at most about 7 N, at most about 5 N, at most about 3 N, at most about 1 N, or less.

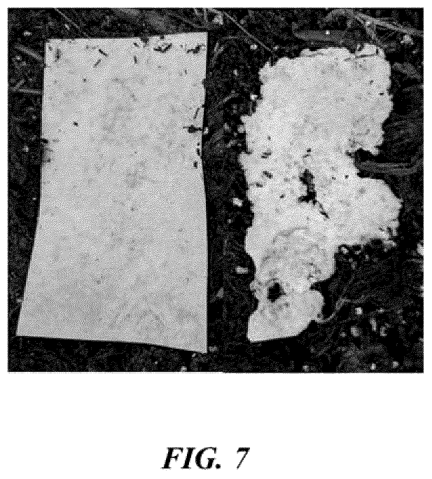

The composition can be biodegradable in a relatively short period of time. Such a property can enable natural breakdown of the material, which can reduce the amount of long-term waste present in the environment. In some examples, the composition is biodegradable within 2 years, within 1 year, within 9 month, within 6 months, within 5 months, within 4.5 months, within 4 months, within 3.5 months, within 3 months, within 2.5 months, within 2 months, within 1.5 months, within 1 month, within 0.5 months or less. In some cases, the composition is biodegradable via hydrolysis. An example of the compositions biodegradable properties is shown in the photographs depicted in FIG. 7. As shown in FIG. 7, significant degradation of the composition is observed after 15 days.

The composition can have a relatively long shelf-life, which can help reduce needs to replace the composition with some more newly produced. A shelf-life of a composition provided herein may be at least 1 month, at least 2 months, at least 5 months, at least 6 months, at least 1 year, at least 1.25 years, at least 1.5 years, at least 1.75 years, at least 2 years, at least 3 years, at least 5 years, at least 10 years, or more.

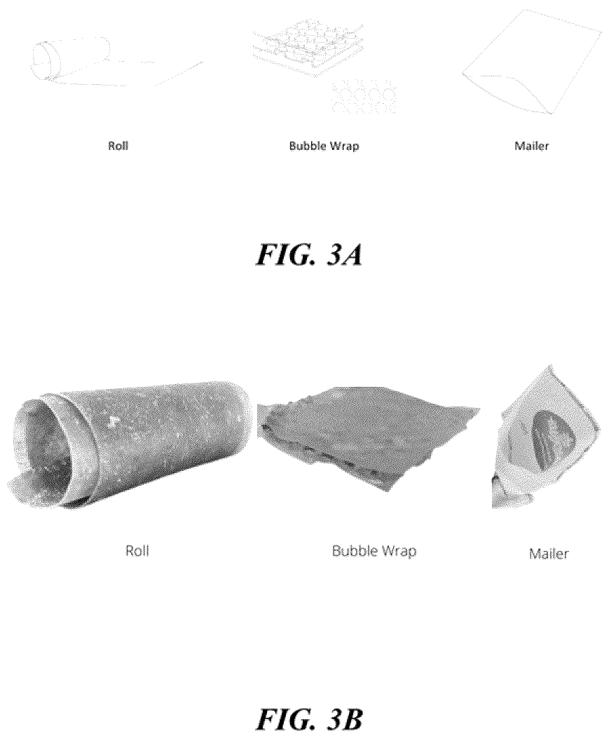

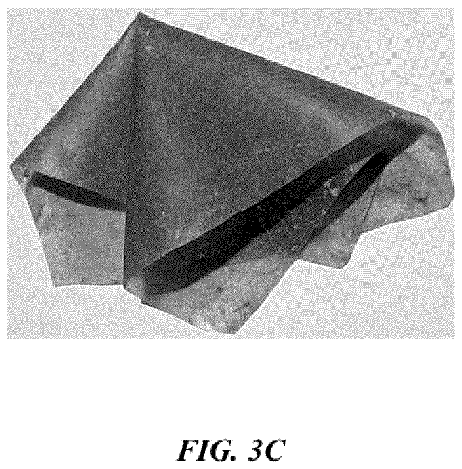

Compositions described herein can be shaped into a variety of form factors. In some cases, the composition is configured as a sheet, such as a film. The sheet can have varying thickness depending upon, for example, the specific process and material component ratios used to produce the composition. The various components of the composition and their ratios can, in some cases, render the composition flexible. Examples of form factors, including a sheet (e.g., film), a rolled sheet, bubble wrap and a mailer are depicted in FIGS. 3A-3C. The thickness of the film shown in FIG. 3C has a thickness of about 1 mm, though may range from 0.01-10 mm depending on specific production method and material component ratios used.

The compositions provided herein can be useful in a variety of practical contexts. Such contexts include packaging, protecting consumer products, including food, clothing, cosmetics, and soap. Other example contexts include use as covering in the construction, agriculture, lumbering, shipping and logistics industries; recycling into fiber products (e.g., molded fiber products); and use in the papermaking industry. Moreover, compositions described herein can, despite their different components, mimic conventional plastics, including woven poly tart, polyethylene (high-density or low-density), and Poly(p-phenyle) oxide (PPE).

### Methods

An additional aspect of the disclosure provides a method comprising: (a) providing a fibrous material, a polysaccharide, a gelatinization agent and a plasticizer to a reactor, thereby obtaining a mixture in the reactor; and (b) in the reactor, heating material of the mixture at temperature(s) sufficient to transition the material through a plurality of material transition phases and thereby obtain a product. In some cases, the gelatinization agent comprises water.

Heating can be performed for less than or equal to 5 hours, less than or equal to 4 hours, less than or equal to 3 hours, less than or equal to 120 minutes, less than or equal to 90 minutes, less than equal to 60 minutes, less than or equal to 50 minutes, less than or equal to 40 minutes, less than or equal to 30 minutes, less than or equal to 25 minutes, less than or equal to 20 minutes, less than or equal to 15 minutes, less than or equal to 10 minutes, less than or equal to 5 minutes, or less. In some cases, heating is continuous as part of continuous production process.

The product can have varied viscosity depending upon, for example, the particular heating time used and components fractions used to generate the product. In some examples, the dynamic viscosity of the product is between about 100 centipoise (cP) and about 5,000,000 cP. In some examples, the dynamic viscosity is between about 1000 cP to about 4,000,000 cP, between about 1000 cP and about 3,000,000 cP, between about 1000 cP and about 2,000,000 cP, between about 1000 cP and about 1,000,000 cP.

In some cases, the dynamic viscosity of the product is at least about 100 cP, at least about 500 cP, at least about 1000 cP, at least about 5000 cP, at least about 10000 cP, at least about 50000 cP, at least about 100000 cP, at least about 500000 cP, at least about 1000000 cP, at least about 2000000 cP, at least about 3000000 cP, at least about 4000000 cP, at least about 5000000 cP, or more. In some cases, the dynamic viscosity of a composition described herein is at most 5000000 cP, at most about 4000000 cP, at most about 3000000 cP, at most about 2000000 cP, at most about 1000000 cP, at most about 500000 cP, at most about 100000 cP, at most about 50000 cP, at most about 10000 cP, at most about 5000 cP, at most about 1000 cP, at most about 500 cP, at most about 100 cP, or less.

Another aspect of the disclosure provides a method comprising: (a) providing a fibrous material, a polysaccharide, gelatinization agent and a plasticizer to a reactor, thereby obtaining a mixture in the reactor; and (b) in the reactor, heating material of the mixture at temperature(s) sufficient to transition the material through a plurality of material transition phases and thereby obtain a product, wherein the product has a dynamic viscosity.

The product can have varied viscosity depending upon, for example, the particular heating time used and components fractions used to generate the product. In some examples, the dynamic viscosity of the product is between about 100 centipoise (cP) and about 5,000,000 cP. In some examples, the dynamic viscosity is between about 1000 cP to about 4,000,000 cP, between about 1000 cP and about 3,000,000 cP, between about 1000 cP and about 2,000,000 cP, between about 1000 cP and about 1,000,000 cP.

In some cases, the dynamic viscosity of the product is at least about 100 cP, at least about 500 cP, at least about 1000 cP, at least about 5000 cP, at least about 10000 cP, at least about 50000 cP, at least about 100000 cP, at least about 500000 cP, at least about 1000000 cP, at least about 2000000 cP, at least about 3000000 cP, at least about 4000000 cP, at least about 5000000 cP, or more. In some cases, the dynamic viscosity of a composition described herein is at most 5000000 cP, at most about 4000000 cP, at most about 3000000 cP, at most about 2000000 cP, at most about 1000000 cP, at most about 500000 cP, at most about 100000 cP, at most about 50000 cP, at most about 10000 cP, at most about 5000 cP, at most about 1000 cP, at most about 500 cP, at most about 100 cP, or less.

In various aspects, the method can further comprise, in (a), providing a slurry comprising the fibrous material and a gelatinization agent to the reactor. The gelatinization agent can be water. In various aspects, the method may also comprise generating the slurry by subjecting a precursor fibrous material and the gelatinization agent to pulping. Pulping can defiber fibrous material into its constituent fibers to help ensure bonding of fibers to polysaccharide. The slurry can also be formed from fibrous material and another liquid medium, separate from the gelatinization agent, with the gelatinization agent added to the process after slurry formation. Defibring of fibrous material can also be done in the absence of any liquid.

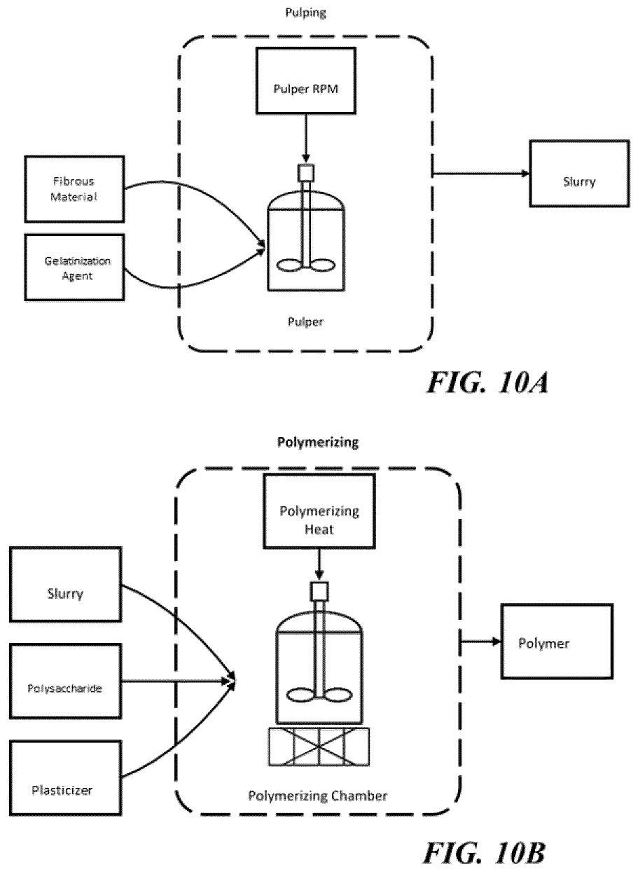

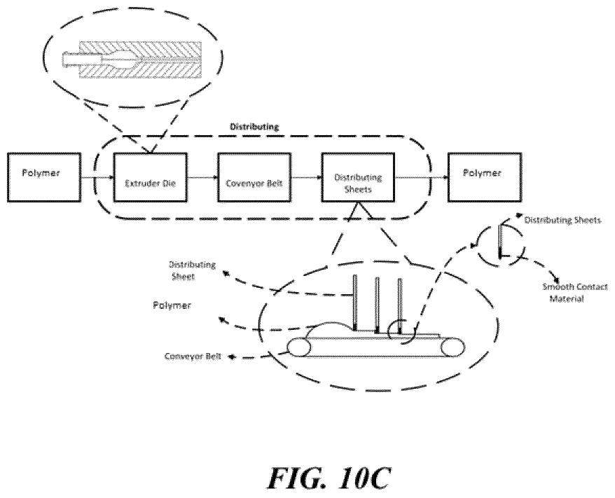

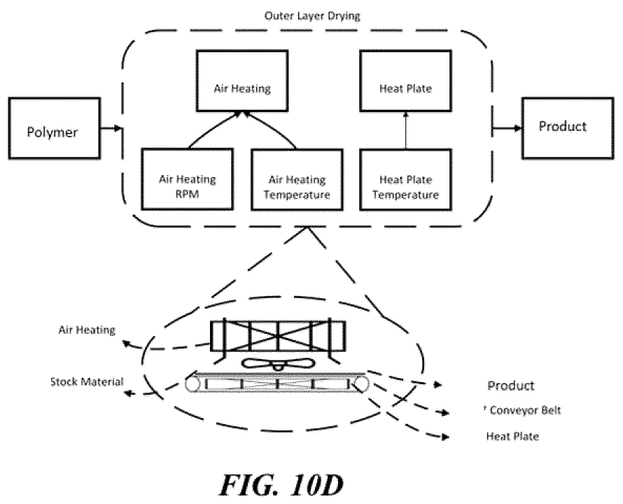

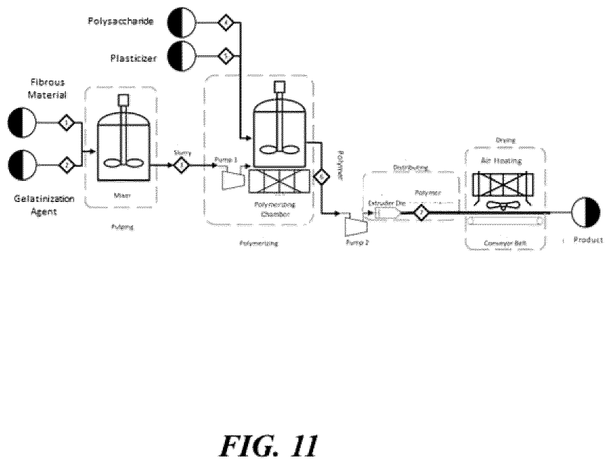

An example pulping process is schematically depicted in FIG. 10A. As shown in FIG. 10A, fibrous material (e.g., cellulose, such as cellulose obtained from any source described herein, including virgin fiber sheets, OCC, and paper) and gelatinization agent (e.g., water) are provided to a reactor (e.g., “pulper”), mixed and pulverized. Mixing and pulverization can be achieved via agitation at speeds ranging from 1,000 to 60,000 RPM for times of 1 to 60 min. Pulverized product results in the formation of a slurry comprising the fibrous material and the gelatinization agent. The process can be continuous or batch. Moreover, pulping can be achieved via an attrition rotor or helical rotor. In some cases, the reactor is a commercially available blender. In some cases, complete pulverization of fibrous material is achieved. In some cases, pulping is continuous pulping whereby pulping is a non-stop process.

In various aspects, in (a), the fibrous material, the polysaccharide, the plasticizer and the gelatinization agent are provided to the reactor simultaneously. In various aspects, in (a), at least one of the fibrous material, the polysaccharide, the gelatinization agent and the plasticizer is provided separately to the reactor. In various aspects, in (b), the plurality of material transition phases comprises a gelatinization phase, a plastification phase and a fibrous bonding phase. In various aspects, in (b), a shear stress is applied to the mixture. Addition of a shear stress can minimize or prevent overheating and also accelerate reaction times.

In various aspects, the method further comprises, in (b) polymerization of one or more materials of the mixture. An example process that can include polymerization of materials is schematically depicted in FIG. 10B. As shown in FIG. 10B, slurry (e.g., such as slurry generated in the example process depicted in FIG. TOA) comprising fibrous material and gelatinization agent (e.g., water) is mixed with polysaccharide and a plasticizer (e.g., glycerol) inside the reactor (e.g., “polymerizing chamber”). Heat is applied to the mixture at a temperature and for a duration sufficient for product formation (example temperatures and times described elsewhere herein), here a polymer. Shear stress can be applied to avoid overheating resulting from direct material contact with the heating element and accelerate the polymerization process. During the reaction, the mixture will transition through phases, including gelatinization, plastification, and fiber bonding, resulting in a high viscosity thermoplastic polymer. During the gelatinization phase, the gelatinization agent (e.g., water) can trigger a phase transition for the polysaccharide (e.g., starch), from an ordered granular structure into a disordered state. As a result, the material can mimic the viscoelastic behavior of a thermoplastic polymer. During the plastification phase, a plasticizer (e.g., glycerol) can enhance the mechanical properties of the resulting thermoplastic material, by increasing the elasticity of the resulting material (as shown in FIG. 6D). Fibrous materials (e.g., cellulose) reinforce the material, enhance the mechanical properties (e.g., tensile strength, puncture strength, tear resistance, elasticity) and increase the material's water resistance by creating stronger bonds. In some cases, the production process comprises simultaneously executing the four stages: mixing, gelatinizing, plasticizing, and fiber bonding, to achieve a faster process (e.g., over 70% faster, over 75% faster, over 80% faster, over 85% faster, over 90% faster, over 95% faster, over 99% faster, over 100% faster or faster than a separated-step process), and reduce heat consumption, production cost, and carbon footprint.

In various aspects, the fibrous material and the plasticizer are provided to the reactor at a weight-percent ratio of fibrous material to plasticizer is from about 0.01 to about 10. In various aspects, the weight-percent ratio of fibrous material to plasticizer provided to the reactor is from about 0.01 to about 5, from about 0.01 to about 1, from about 0.01 to about 0.1, from about 0.01 to about 0.05, from about 0.03 to about 0.05, from about 0.03 to about 1, from about 0.03 to about 5, from about 0.03 to about 10, from about 0.05 to about 10, from about 0.05 to about 1, from about 1 to about 10, from about 2 to about 10, from 5 to about 10.

In various aspects, the weight-percent ratio of fibrous material to plasticizer provided to the reactor is at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, or more. In various aspects, the weight-percent ratio of fibrous material to plasticizer provided to the reactor is at most 10, at most 9, at most 8, at most 7, at most 6, at most 5, at most 4, at most 3, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most at 0.06, at most at 0.05, at most 0.04, at most 0.03, at most 0.02, at most 0.01, or less.

In various aspects, the weight-percent ratio of polysaccharide to plasticizer provided to the reactor is from about 0.01 to about 20. In various aspects, the weight-percent ratio of polysaccharide to plasticizer provided to the reactor is from about 0.01 to about 5, from about 0.01 to about 1, from about 0.01 to about 0.1, from about 0.01 to about 0.05, from about 0.03 to about 0.05, from about 0.03 to about 0.8, from about 0.03 to about 1, from about 0.03 to about 5, from about 0.03 to about 10, from about 0.05 to about 10, from about 0.05 to about 1, from about 1 to about 10, from about 2 to about 10, from about 3 to about 10, from about 4 to about 10, from about from 5 to about 10, from about 6 to about 10, from about 7 to about 10, from about 8 to about 10, from about 9 to about 10.

In various aspects, the weight-percent ratio of polysaccharide to plasticizer provided to the reactor is at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 12, at least 14, at least 16, at least 18, at least 20 or more. In various aspects, the weight-percent ratio of polysaccharide to plasticizer provided to the reactor is at most 20, at most 18, at most 16, at most 14, at most 12, at most 10, at most 9, at most 8, at most 7, at most 6, at most 5, at most 4, at most 3, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most at 0.06, at most at 0.05, at most 0.04, at most 0.03, at most 0.02, at most 0.01, or less.

In various aspects, the weight-percent ratio of fibrous material to polysaccharide provided to the reactor is from about 0.01 to about 10. In various aspects, the weight-percent ratio of fibrous material to polysaccharide provided to the reactor is from about 0.01 to about 5, from about 0.01 to about 1, from about 0.01 to about 0.1, from about 0.01 to about 0.05, from about 0.03 to about 0.05, from about 0.03 to about 1, from about 0.03 to about 5, from about 0.03 to about 10, from about 0.05 to about 10, from about 0.05 to about 1, from about 1 to about 10, from about 2 to about 10, from 5 to about 10.

In various aspects, the weight-percent ratio of fibrous material to polysaccharide provided to the reactor is at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, or more. In various aspects, the weight-percent ratio of fibrous material to polysaccharide provided to the reactor is at most 10, at most 9, at most 8, at most 7, at most 6, at most 5, at most 4, at most 3, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most at 0.06, at most at 0.05, at most 0.04, at most 0.03, at most 0.02, at most 0.01, or less.

In various aspects, the weight-percent ratio of polysaccharide to gelatinization agent provided to the reactor is from about 0.0001 to about 1. In various aspects, the weight-percent ratio of polysaccharide to gelatinization provided to the reactor is from about 0.0001 to about 0.5, from about 0.0001 to about 0.1, from about 0.001 to about 1, from about 0.001 to about 0.8, from about 0.001 to about 0.6, from about 0.001 to about 0.4, from about 0.001 to about 0.4, from about 0.001 to about 0.2, from about 0.001 to about 0.08, from about 0.001 to about 0.06, from about 0.001 to about 0.06, from about 0.001 to about 0.04, from about 0.001 to about 0.02, from about 0.0001 to about 0.0008, from about 0.0001 to about 0.0006, or from about 0.0001 to about 0.0004.

In various aspects, the weight-percent ratio of polysaccharide to gelatinization agent provided to the reactor is at least 0.0001, at least 0.0002, at least 0.0003, at least 0.0004, at least 0.0005, at least 0.0006, at least 0.0007, at least 0.0008, at least 0.0009, at least 0.001, at least 0.002, at least 0.003, at least 0.004, at least 0.005, at least 0.006, at least 0.007, at least 0.008, at least 0.009, at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1 or more. In various aspects, the weight-percent ratio polysaccharide to gelatinization agent provided to the reactor is at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most 0.06, at most 0.05, at most 0.04, at most 0.03, at most 0.02, at most 0.01, at most 0.009, at most 0.008, at most 0.007, at most at 0.006, at most 0.005, at most 0.004, at most 0.003, at most 0.002, at most 0.001, at most 0.09, at most 0.08, at most 0.07, at most 0.06, at most 0.05, at most 0.04, at most 0.03, at most 0.02, at most 0.01, at most 0.0009, at most 0.0008, at most 0.0007, at most at 0.0006, at most 0.0005, at most 0.0004, at most 0.0003, at most 0.0002, at most 0.0001, or less.

In various aspects, the weight-percent ratio of fibrous material to gelatinization agent provided to the reactor is from about 0.0001 to about 1. In various aspects, the weight-percent ratio of fibrous material to gelatinization provided to the reactor is from about 0.0001 to about 0.5, from about 0.0001 to about 0.1, from about 0.001 to about 1, from about 0.001 to about 0.8, from about 0.001 to about 0.6, from about 0.001 to about 0.4, from about 0.001 to about 0.4, from about 0.001 to about 0.2, from about 0.001 to about 0.08, from about 0.001 to about 0.06, from about 0.001 to about 0.06, from about 0.001 to about 0.04, from about 0.001 to about 0.02, from about 0.0001 to about 0.0008, from about 0.0001 to about 0.0006, or from about 0.0001 to about 0.0004.

In various aspects, the weight-percent ratio of fibrous material to gelatinization agent provided to the reactor is at least 0.0001, at least 0.0002, at least 0.0003, at least 0.0004, at least 0.0005, at least 0.0006, at least 0.0007, at least 0.0008, at least 0.0009, at least 0.001, at least 0.002, at least 0.003, at least 0.004, at least 0.005, at least 0.006, at least 0.007, at least 0.008, at least 0.009, at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1 or more. In various aspects, the weight-percent ratio fibrous material to gelatinization agent provided to the reactor is at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most 0.06, at most 0.05, at most 0.04, at most 0.03, at most 0.02, at most 0.01, at most 0.009, at most 0.008, at most 0.007, at most at 0.006, at most 0.005, at most 0.004, at most 0.003, at most 0.002, at most 0.001, at most 0.09, at most 0.08, at most 0.07, at most 0.06, at most 0.05, at most 0.04, at most 0.03, at most 0.02, at most 0.01, at most 0.0009, at most 0.0008, at most 0.0007, at most at 0.0006, at most 0.0005, at most 0.0004, at most 0.0003, at most 0.0002, at most 0.0001, or less.

In various aspects, the fibrous material provided to the reactor comprises cellulose, Winceyette Fibers, liganocelluose, nano cellulose, straw (e.g., Barley, Canola, Oat, Wheat, etc.), chitin, chitosan, silk, collagen, keratin, wool, hair, sinew, catgut, angora, mohair, cellulose nano crystals (CNC). In various aspects, the fibrous material provided in a reactor is cellulose or a derivative thereof. In various aspects, the cellulose provided in a reactor is wood cellulose. In various aspects, the cellulose provided in a reactor is anhydrocellulose. In various aspects, the cellulose provided in a reactor is a natural fiber. Moreover, the fibrous material can be obtained and/or derived from any suitable source, with non-limiting examples that include food, organic waste, corrugated cardboard, recycled paper and Virgin fibers. Furthermore, the fibrous material provided in a reactor can be a polymeric species. In cases the fibrous materials are recycled fibers. Individual subunits of such a polymeric species can be linked together via glycosidic bonds.

In various aspects, the polysaccharide provided to the reactor is a form of starch or derivative of a form of starch. Non-limiting examples of starch and starch derivatives include pea starch, potato starch, moonbeam starch, corn starch, tapioca starch, arrowroot starch, rice starch, wheat starch, captured carbon based starch and starch from tree matter.

In various aspects, the plasticizer provided to the reactor is selected from the group consisting of glycerol, maltose, urea, sorbitol, sucrose, fructose, glucose, formamide, citric acid, amino acid, malic acid, ethylenebisformamide, buriti oil, polyethylene glycol, acetamide, ethanolamine, isoleucine, asparagine, ethanolamine, polyoils, lecithin, monoglycerides, propylene glycol, diethyleneoxide glycol, triethyleneoxide glycol and poliethyleneoxide glycol. In various aspects, the plasticizer provided in a reactor is glycerol or derivative thereof.

In various aspects, a method further comprises providing acetic acid to the reactor such that the mixture comprises the acetic acid. Varied amount of acetic acid can be provided. In some cases, the weight-percent ratio of acetic acid to fibrous material provided to the reactor is from about 0.01 to about 50. In some cases, the weight-percent ratio of acetic acid to fibrous material provided to the reactor is from about 0.01 to about 25, from about 0.01 to about 10, from about 0.1 to about 45, from about 0.1 to about 40, from about 0.1 to about 35, from about 0.1 to about 30, from about 0.1 to about 25, from about 0.1 to about 20, from about 0.1 to about 15, from about 0.1 to about 10, from about 0.1 to about 5 or from about 0.1 to about 1.

In some cases, the weight-percent ratio of acetic acid to fibrous material provided to the reactor is at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 15, at least 20, at least 25, at least 30, at least 35, at least 40, at least 45, at least 50, or more.

In some cases, the weight-percent ratio of acetic acid to fibrous material provided to the reactor is at most 50, at most 45, at most 40, at most 35, at most 30, at most 25, at most 20, at most 15, at most 10, at most 9, at most 8, at most 7, at most 6, at most 5, at most 4, at most 3, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most 0.06, at most 0.05, at most 0.04, at most 0.03, at most 0.02, at most 0.01, or less.

In some cases, the weight-percent ratio of acetic acid to polysaccharide provided to the reactor is from about 0.001 to about 20. In some cases, the weight-percent ratio of acetic acid to polysaccharide provided to the reactor is from about 0.001 to about 10, from about 0.001 to about 5, from about 0.001 to about 2, from about 0.001 to about 1, from about 0.01 to about 10, from about 0.01 to about 5, from about 0.01 to about 2 or from about 0.01 to about 1.

In some cases, the weight-percent ratio of acetic acid to polysaccharide provided to the reactor is at least 0.001, at least 0.002, at least 0.003, at least 0.004, at least 0.005, at least 0.006, at least 0.007, at least 0.008, at least 0.009, at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 5, at least 10 at least 20 or more.

In some cases, the weight-percent ratio of acetic acid to polysaccharide provided to the reactor is at most 20, at most 10, at most 5, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most 0.06, at most 0.05, at most 0.04, at most 0.03, at most 0.02, at most 0.01, at most 0.009, at most 0.008, at most 0.007, at most 0.006, at most 0.005, at most 0.004, at most 0.003, at most 0.002, at most 0.001, or less.

In some cases, the weight-percent ratio of acetic acid to gelatinization agent provided to the reactor is from about 0.0001 to about 1. In some cases, the weight-percent ratio of acetic acid to gelatinization agent provided to the reactor is from about 0.001 to about 1, from about 0.001 to about 0.5, from about 0.001 to about 0.1, from about 0.001 to about 0.05, from about 0.001 to about 0.01 or from about 0.001 to about 0.005.

In some cases, the weight-percent ratio of acetic acid to gelatinization agent provided to the reactor is at least 0.0001, at least 0.0002, at least 0.0003, at least 0.0004, at least 0.0005, at least 0.0006, at least 0.0007, at least 0.0008, at least 0.0009, at least 0.001, at least 0.002, at least 0.003, at least 0.004, at least 0.005, at least 0.006, at least 0.007, at least 0.008, at least 0.009, at least 0.01, at least 0.02, at least 0.03, at least 0.04, at least 0.05, at least 0.06, at least 0.07, at least 0.08, at least 0.09, at least 0.1, at least 0.2, at least 0.5, at least 1 at least 5 or more.

In some cases, the weight-percent ratio of acetic acid to gelatinization agent provided to the reactor is at most 5, at most 1, at most 0.5, at most 0.2, at most 0.1, at most 0.09, at most 0.08, at most 0.07, at most 0.06, at most 0.05, at most 0.04, at most 0.03, at most 0.02, at most 0.01, at most 0.009, at most 0.008, at most 0.007, at most 0.006, at most 0.005, at most 0.004, at most 0.003, at most 0.002, at most 0.001, at most 0.0009, at most 0.0008, at most 0.0007, at most 0.0006, at most 0.0005, at most 0.0004, at most 0.0003, at most 0.0002, at most 0.0001, or less.

In some cases, the weight-percent ratio of acetic acid to plasticizer provided to the reactor is from about 0.01 to about 50. In some cases, the weight-percent ratio of acetic acid to plasticizer provided to the reactor is from about 0.01 to about 25, from about 0.01 to about 10, from about 0.1 to about 45, from about 0.1 to about 40, from about 0.1 to about 35, from about 0.1 to about 30, from about 0.1 to about 25, from about 0.1 to about 20, from about 0.1 to about 15, from about 0.1 to about 10, from about 0.1 to about 5 or from about 0.1 to about 1.

In some cases, the weight-percent ratio of acetic acid to plasticizer provided to the reactor is at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, at least 0.9, at least 1, at least 2, at least 3, at least 4, at least 5, at least 6, at least 7, at least 8, at least 9, at least 10, at least 15, at least 20, at least 25, at least 30, at least 35, at least 40, at least 45, at least 50, or more.

In some cases, the weight-percent ratio of acetic acid to plasticizer provided to the reactor is at most 50, at most 45, at most 40, at most 35, at most 30, at most 25, at most 20, at most 15, at most 10, at most 9, at most 8, at most 7, at most 6, at most 5, at most 4, at most 3, at most 2, at most 1, at most 0.9, at most 0.8, at most 0.7, at most 0.6, at most 0.5, at most 0.4, at most 0.3, at most 0.2, at most 0.1, at most 0.09, at most 0.08, at most 0.07, at most 0.06, at most 0.05, at most 0.04, at most 0.03, at most 0.02, at most 0.01, or less.

In various aspects, in (b), the temperature in the reactor is from about 20° C. to about 1000° C. in a reactor. In various aspects, in (b), the temperature in the reactor is from about 25° C. to about 1000° C., from about 30° C. to about 900° C., from about 35° C. to about 800° C., from about 40° C. to about 700° C., from about 45° C. to about 650° C., from about 45° C. to about 600° C., from about 45° C. to about 550° C., from about 50° C. to about 500° C., from about 60° C. to about 450° C., from about 60° C. to about 400° C., from about 70° C. to about 300° C., from about 80° C. to about 200° C., from about 25° C. to about 900° C., from about 25° C. to about 850° C., from about 25° C. to about 800° C., from 25° C. to about 750° C., from about 25° C. to about 700° C., from about 25° C. to about 650° C., from about 25° C. to about 600° C., from about 25° C. to about 500° C., from about 25° C. to about 400° C., from about 25° C. to about 300° C., from about 25° C. to about 200° C., from about 30° C. to about 850° C., from about 30° C. to about 800° C., from about 30° C. to about 750° C., from about 30° C. to about 700° C., from about 30° C. to about 650° C., from about 30° C. to about 600° C., from about 30° C. to about 500° C., from about 30° C. to about 400° C., from about 30° C. to about 300° C., from about 30° C. to about 200° C., from about 35° C. to about 750° C., from about 35° C. to about 700° C., from about 35° C. to about 600° C., from about 35° C. to about 500° C., from about 35° C. to about 450° C., from about 35° C. to about 400° C., from about 35° C. to about 350° C., from about 35° C. to about 300° C., from about 35° C. to about 250° C., from about 35° C. to about 200° C., from about 40° C. to about 800° C., from about 40° C. to about 750° C., from about 40° C. to about 650° C., from about 40° C. to about 600° C., from 40° C. to about 550° C., from about 40° C. to about 500° C., from about 40° C. to about 450° C., from about 40° C. to about 400° C., from about 40° C. to about 350° C., from about 40° C. to about 300° C., from about 40° C. to about 250° C., from about 40° C. to about 200° C.

In various aspects, in (b), the temperature in the reactor is at least 20° C., at least 25° C., at least 30° C., at least 35° C., at least 40° C., at least 45° C., at least 50° C., at least 60° C., at least 70° C., at least 80° C., at least 100° C., at least 120° C., at least 150° C., at least 175° C., at least 200° C., at least 250° C., at least 300° C., at least 350° C., at least 400° C., at least 500° C., at least 600° C., at least 700° C., at least 800° C., at least 900° C., at least 1000° C.

In various aspects, the temperature in the reactor is at most about 1000° C., at most about 900° C., at most about 800° C., at most about 700° C., at most about 600° C., at most about 500° C., at most about 450° C., at most about 400° C., at most about 350° C., at most about 300° C., at most about 250° C., at most about 200° C., at most about 175° C., at most about 150° C., at most about 120° C., at most about 100° C., at most about 80° C., at most about 70° C., at most about 60° C., at most about 50° C., at most about 45° C., at most about 40° C., at most about 35° C., at most about 30° C., at most about 25° C., at most about 20° C.

In various aspects, the method further comprises, after (b), subjecting the product to extrusion to obtain an extruded product. In various aspects, after extrusion, the method further comprises form-factoring the extruded product to obtain a form-factored product. The product can take on any desired form-factor, with non-limiting examples provided elsewhere herein. In various aspects, a method further comprises, the forming-factored product is configured as a sheet/film.

An example of extrusion and form-factoring processes is schematically depicted in FIG. 10C. Polymer (e.g., high viscosity polymer, such as polymer generated in the example process depicted in FIG. 10B) is transported towards a heat-resistant conveyor belt through a piping system, which finishes in an extruder (e.g., extruder die), which can uniformly distribute the material on the belt. The extruder die can include one or more of: a central inlet port where the polymer flows from the polymerizing chambers towards the inside of the die through piping; a manifold; a chamber to accumulate polymer to balance the material flow, for even distribution and speed as the polymer coming out of the die; an island, to provide a balanced flow and uniform flow, minimizing the pressure drop; and die lips for a smooth transition from the inside of the extruder die towards the conveyor belt, by providing control over the polymer thickness and distribution. Geometry of the die lips and the belts can be designed for particular product geometries, including, for example, thickness and distribution. A rigid distributing sheet with smooth contact materials in one of their vertices, is in direct contact with polymer as it traverses via the conveyor belt, blocking its flow beyond a specific thickness, resulting in a uniform distribution with a controlled thickness. The smooth contact materials can be constructed of an abrasion-resistant material (e.g., comprising silicone or Teflon®). This process phase reduces polymer heterogeneity. In various aspects, an angular rotation of the distributing sheet may be applied to generate a counter flow to remove excess material. In this example, polymer forms into a product, form-factored as a film.

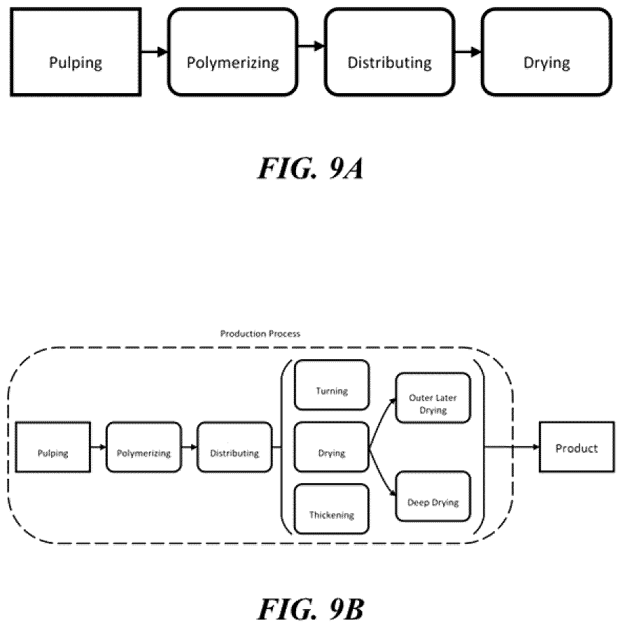

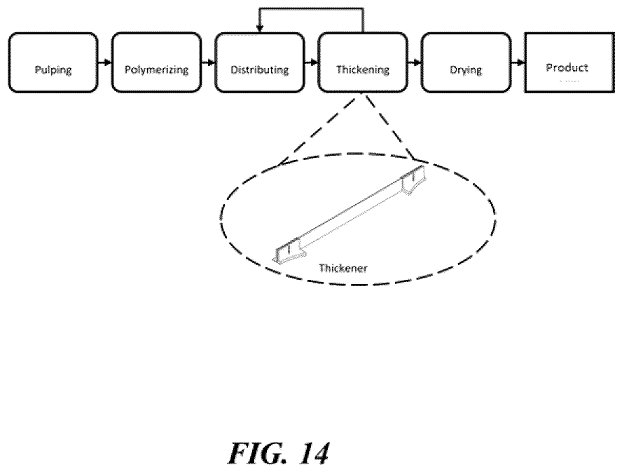

In various aspects, the method further comprises subjecting the form-factored product to drying. In various aspects, drying can be performed after form-factoring (e.g., distribution) as shown in the examples of FIGS. 9A and 9B. Drying can also be performed during form-factoring. In various aspects the method further comprises, subjecting the form-factored product to thickening. An example drying process is schematically depicted in FIG. 10D. In this example, drying comprises outer layer drying and optional deep drying. As shown in FIG. 10D, during outer layer drying, to accelerate the stock material's outer layer transition from a liquid stage towards a solid viscoelastic phase, air heating (e.g., forced heating) is applied to the polymer (e.g., high viscosity polymer), and is placed at a distance ranging from 0.5 to 500 millimeters, at temperature ranging from 20° C. to 200° C. An optional heating element (e.g., a Heat Plate) is also applied underneath the conveyor belt, drying the stock material from the contact layer through inner layer, at a temperature range from 20° C. to 300° C., for about 1 second to 60 minutes. In various aspects, the stock material may transition towards a viscoelastic solid state, which maintains its embodiment or to be redefined by external forces. The stock material (e.g., in viscoelastic solid state) may advance through the conveyor belt towards an abrasion-resistant thickening rollers made of materials comprising silicone, PVC or Teflon®, to ensure the thickness desired. In various aspects, heat is applied from inside of the thickening rollers to accelerate the drying process. In various aspects, the material is compressed between thickening rollers. In various aspects, the material transitions towards a product (e.g., wet flexible film) with the predetermined thickness. Furthermore, example processes including both thickening and drying are schematically depicted in FIG. 9B and FIG. 14. The example in FIG. 9B, also includes a turning process.

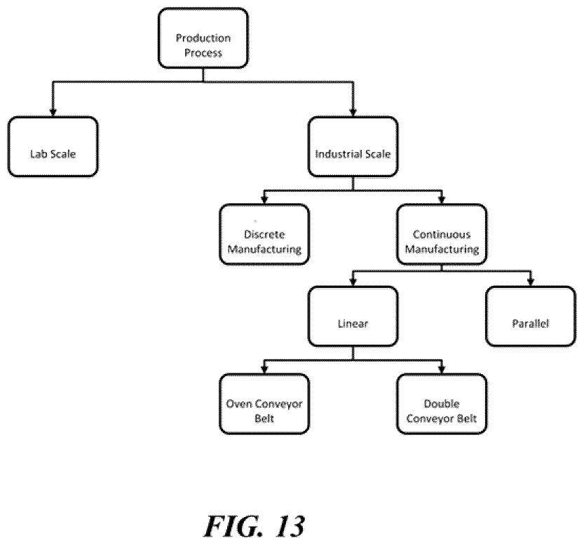

Processes described herein can be run at various scales and in various modes. Examples of such possibilities are conceptually shown in FIG. 13. Production methods can be run at either industrial or lab scale. They can also be run in discrete/batch and/or continuous modes. In some cases, processes can be linear in that each stage performs a given operation, or one or more stages can be run in parallel such that multiple operations are combined in a single stage. Various examples of continuous or discrete and/or linear or continuous operations are described elsewhere herein. In some cases, the converter operations to process the resulting material into a pre-determined form-factor can be reduced for integrated manufacturing facilities where the product (e.g., film) will travel towards a converter autonomously in the same building.

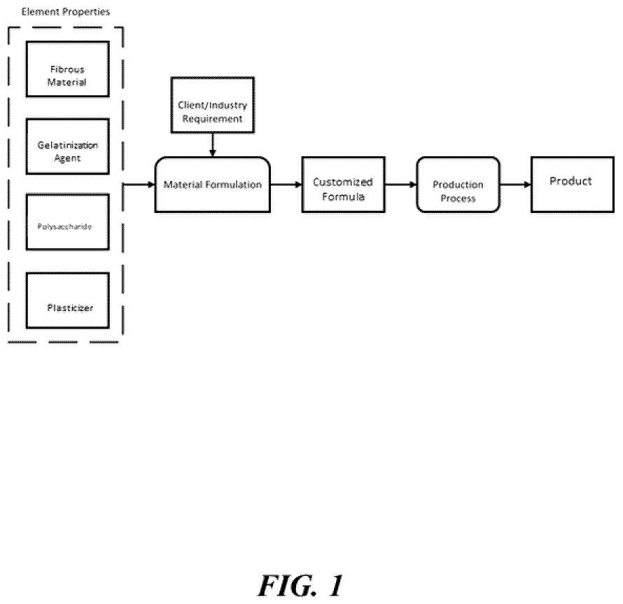

Moreover, given the variety of processing stages, operating parameters, etc. that can be used to generate the variety of compositions herein, material production processes can be customized to generate customized products. Such possibilities are conceptually shown in FIG. 1. As shown in FIG. 1, component materials (e.g., fibrous material, gelatinization agent, polysaccharide, plasticizer) can be custom formulated materially based on a desired outcome. The customized formulation can then be provided to a production process described herein to generate the desired product.

### Computer Control Systems

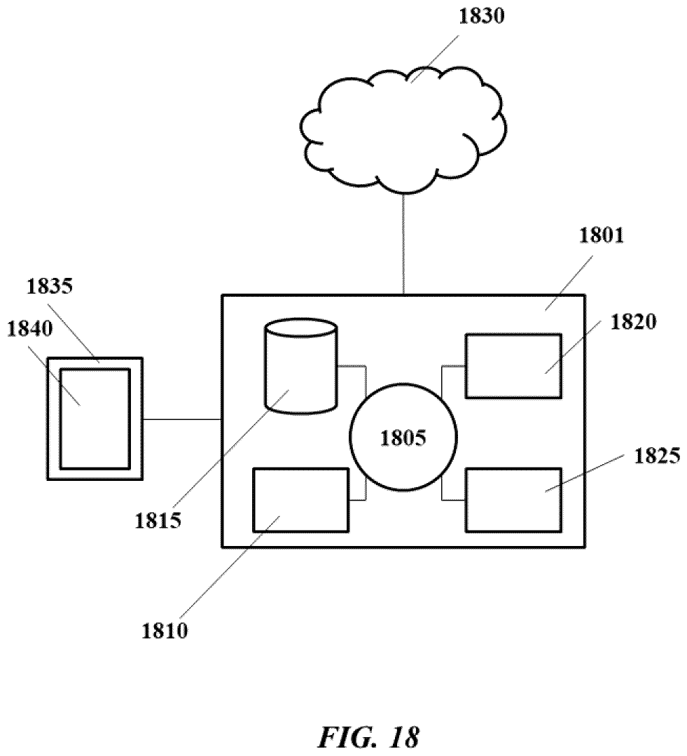

The present disclosure provides computer control systems that are programmed to implement methods of the disclosure. FIG. 18 shows a computer system 1801 that is programmed or otherwise configured to implement methods of the disclosure, including the production of compositions described herein. The computer system 1801 can regulate various aspects of material flow, reaction conditions, operation of unit operations and control one or more parameters of methods of the present disclosure. The computer system 1801 can be an electronic device of a user or a computer system that is remotely located with respect to the electronic device. The electronic device can be a mobile electronic device.

The computer system 1801 includes a central processing unit (CPU, also “processor” and “computer processor” herein) 1805, which can be a single core or multi core processor, or a plurality of processors for parallel processing. The computer system 1801 also includes memory or memory location 1810 (e.g., random-access memory, read-only memory, flash memory), electronic storage unit 1815 (e.g., hard disk), communication interface 1820 (e.g., network adapter) for communicating with one or more other systems, and peripheral devices 1825, such as cache, other memory, data storage and/or electronic display adapters. The memory 1810, storage unit 1815, interface 1820 and peripheral devices 1825 are in communication with the CPU 1805 through a communication bus (solid lines), such as a motherboard. The storage unit 1815 can be a data storage unit (or data repository) for storing data. The computer system 1801 can be operatively coupled to a computer network (“network”) 1830 with the aid of the communication interface 1820. The network 1830 can be the Internet, an internet and/or extranet, or an intranet and/or extranet that is in communication with the Internet. The network 1830 in some cases is a telecommunication and/or data network. The network 1830 can include one or more computer servers, which can enable distributed computing, such as cloud computing. The network 1830, in some cases with the aid of the computer system 1801, can implement a peer-to-peer network, which may enable devices coupled to the computer system 1801 to behave as a client or a server.

The CPU 1805 can execute a sequence of machine-readable instructions, which can be embodied in a program or software. The instructions may be stored in a memory location, such as the memory 1810. The instructions can be directed to the CPU 1805, which can subsequently program or otherwise configure the CPU 1805 to implement methods of the present disclosure. Examples of operations performed by the CPU 1805 can include fetch, decode, execute, and writeback.

The CPU 1805 can be part of a circuit, such as an integrated circuit. One or more other components of the system 1801 can be included in the circuit. In some cases, the circuit is an application specific integrated circuit (ASIC).

The storage unit 1815 can store files, such as drivers, libraries and saved programs. The storage unit 1815 can store user data, e.g., user preferences and user programs. The computer system 1801 in some cases can include one or more additional data storage units that are external to the computer system 1801, such as located on a remote server that is in communication with the computer system 1801 through an intranet or the Internet.

The computer system 1801 can communicate with one or more remote computer systems through the network 1830. For instance, the computer system 1801 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1801 via the network 1830.

Methods as described herein can be implemented by way of machine (e.g., computer processor) executable code stored on an electronic storage location of the computer system 1801, such as, for example, on the memory 1810 or electronic storage unit 1815. The machine executable or machine readable code can be provided in the form of software. During use, the code can be executed by the processor 1805. In some cases, the code can be retrieved from the storage unit 1815 and stored on the memory 1810 for ready access by the processor 1805. In some situations, the electronic storage unit 1815 can be precluded, and machine-executable instructions are stored on memory 1810.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1801 can include or be in communication with an electronic display 1835 that comprises a user interface (UI) 1840 for providing, for example, elements of material product, reaction conditions, material feed amounts, unit operation parameters and unit operation instructions. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1805. The algorithm can, for example, implement methods of disclosure and control unit operations used to execute such methods.

### EXAMPLES

### Example 1—Example Composition

An example composition was prepared using a method described herein. The material components of the composition are tabulated in the table shown in FIG. 5. As shown in FIG. 5, the composition comprises a gelatinization agent (e.g., water), a plasticizer (e.g., glycerol), a polysaccharide (e.g., corn starch), acetic acid and a fibrous material (e.g., wood cellulose). In this example, corn starch acts as a binder, which results in a cohesive whole material, having structural stability. Glycerol acts as a plasticizer in which chemically interacts with the corn starch. This interaction imparts a level of elasticity to the composition. Moreover, the wood cellulose helps in ensuring that the composition does not break during production (e.g., during drying) and also helps ensure a uniform material. Furthermore, the addition of fibrous material and glycerol enhances the mechanical performance of the resulting material, including enhanced tensile strength and elasticity. During production, wood cellulose helps maintain the glycerol+cornstarch+water mixture together during the crystallization (e.g., retrogradation) phase, binding them together. Acetic acid oxides the material, preventing the growth of fungus and/or augmenting the outdoor lifespan of the material. Select properties of the example composition are graphically depicted in the stress-strain curve shown in FIG. 6E. As shown in FIG. 6E, the yield strength of the composition is 12 MPa and a Young's modulus of 161.29 MPa.

### Example 2—Example Compositions

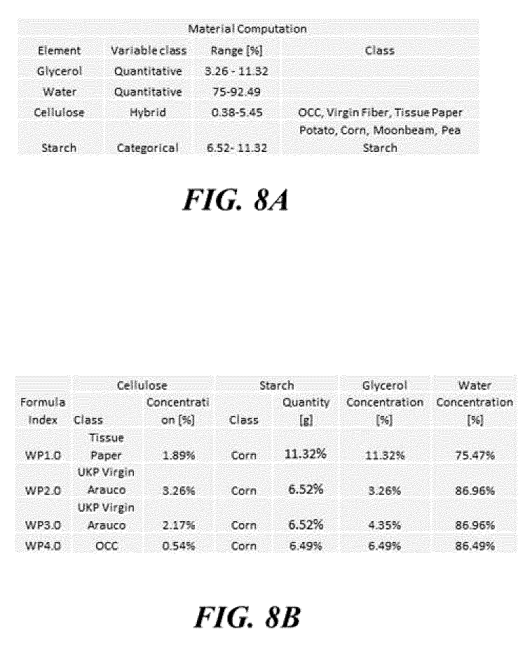

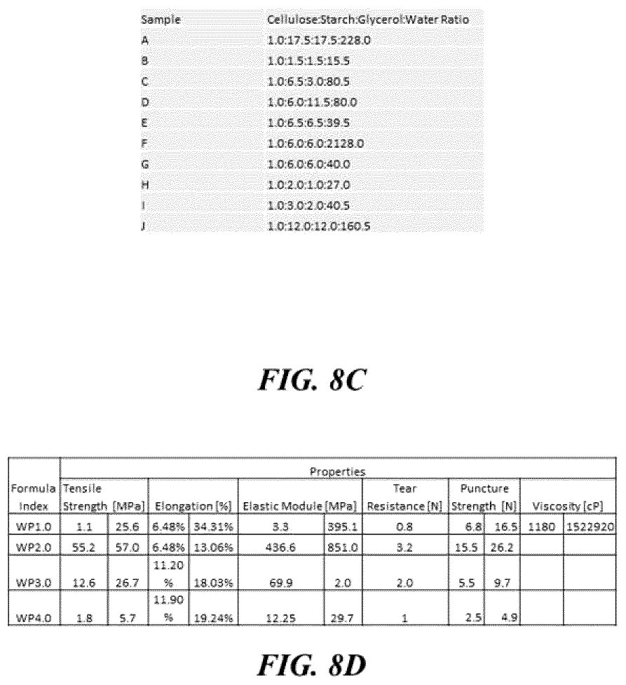

A variety of compositions ranging in amounts of material components are prepared using a production method described herein. Fraction ranges of material components are tabulated in the table of FIG. 8A. As shown in FIG. 8A, the composition comprises a gelatinization agent (e.g., water), a plasticizer (e.g., glycerol), a polysaccharide (e.g., corn starch, potato starch, moonbeam starch, pea starch), acetic acid and a fibrous material (e.g., OCC, Virgin Fiber, Tissue Paper), each component in a range of fractions within the composition.

### Example 3—Example Compositions

A variety of compositions (WP1.0-WP4.0) ranging in amounts of material components are prepared using a production method described herein. Material component fractions are tabulated in the table of FIG. 8B. As shown in FIG. 8B, the composition comprises a gelatinization agent (e.g., water), a plasticizer (e.g., glycerol), a polysaccharide (e.g., corn starch), acetic acid and a fibrous material (e.g., OCC, Virgin Fiber, Tissue Paper), each composition having the material compositions shown. Mechanical properties of the various compositions are tabulated in FIG. 8D.

### Example 4—Example Compositions

A variety of compositions (samples A-J) ranging in fractions of material components are prepared using a production method described herein. Ratios of various material components are tabulated in the table of FIG. 8C. As shown in FIG. 8C, the composition comprises a gelatinization agent (e.g., water), a plasticizer (e.g., glycerol), a polysaccharide (e.g., corn starch), acetic acid and a fibrous material (e.g., cellulose), each composition having the material compositions shown.

### Example 5—Example Variation of Dynamic Viscosity in Material Processing Operations

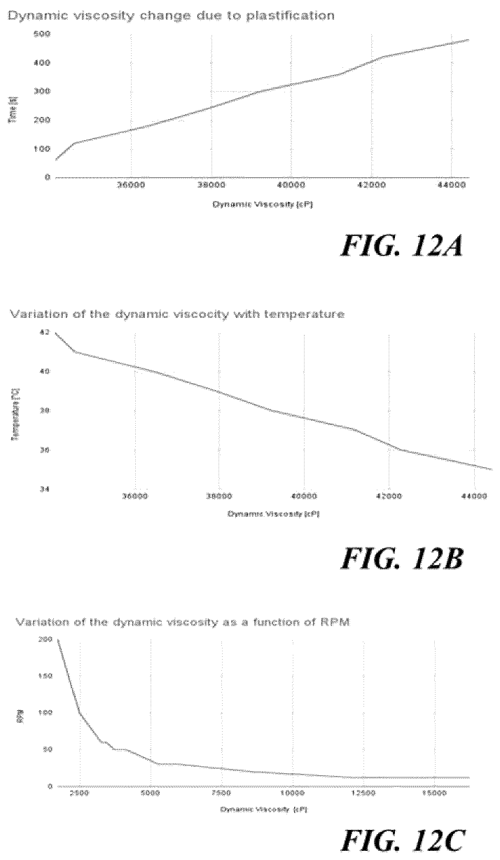

Materials ranging in dynamic viscosity are described elsewhere herein and can be generated using varied production processes. Operating characteristics of various stages of the product generation process can affect product dynamic viscosity achieved. In an example, dynamic viscosity of the generated material increased with increasing plastification times shown in FIG. 12A. In another example, as shown in FIG. 12B, the dynamic viscosity of the material generated increases as the material temperature decreases.

In another example, as shown in FIG. 12C, the dynamic viscosity of the material generated increases as revolutions-per-minute (RPM) of the measuring device decreases. In some cases, the measuring device is the agitator of a polymerization reactor. The agitator-fluid interface can produce a shear stress which can be used to measure dynamic viscosity. Dynamic viscosity can represent the resistance of material movement (e.g., lower resistance at higher RPM). In this example, the material behaves as a shear-thinning fluid, which is indicative of its dynamic viscosity lowering when shear stress increases.

Such behavior can impact processing stages, including polymerization, extrusion, form-factoring, drying, etc. During polymerization, shear stress can be applied through the polymerizing process. The energy consumed by this step can be defined by the material's viscosity. Moreover, shear stress can be applied when the material flows in pipes and inside an extruder due to the contact forces between the polymer and the pipe and extruder walls, which can impact pressure necessary for flow through the process and generate swelling as the material comes out of the extruder. Shear stress can also be applied during form-factoring (e.g., via distributing sheets), which can occur at a different temperature than during polymerization and in pipes and extruder. Dynamic viscosity of the material when it is in contact with the form-factoring equipment (e.g., distributing sheets) can depend on its speed when contacting form-factoring equipment, plastification time and/or material temperature.

### Example 6—Example Production Method

An example process flow diagram is schematically depicted in FIG. 11. As shown in FIG. 11, fibrous material and gelatinization agent are mixed and used to generate a slurry comprising the fibrous material and gelatinization in a pulping process. The resulting slurry is mixed with polysaccharide and plasticizer and subjected to a reaction including polymerization to form a stock material polymer. The stock material polymer is then pumped towards the conveyor belt and distributed by an extruder die during a distributing process. The resulting material is dried through forced convection drying utilizing an air heating device. This will result in a product. Application of a mechanical process instead of a chemical synthesis process can reduce energy consumption, reduce toxin chemicals released to the environment, reduce the cost of production and resulting in a cost-competitive product with a lower carbon footprint. Furthermore, by relying on heat to dry the material can maintain mechanical performance and have a relatively higher elasticity. While this example is shown with use of the gelatinization agent as a liquid medium for the slurry, other liquids could be added with the gelatinization agent added to the process afterwards (e.g., during polymerization).

### Example 7—Example Linear Production Methods

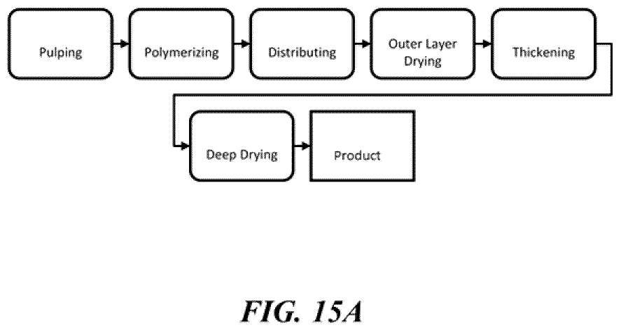

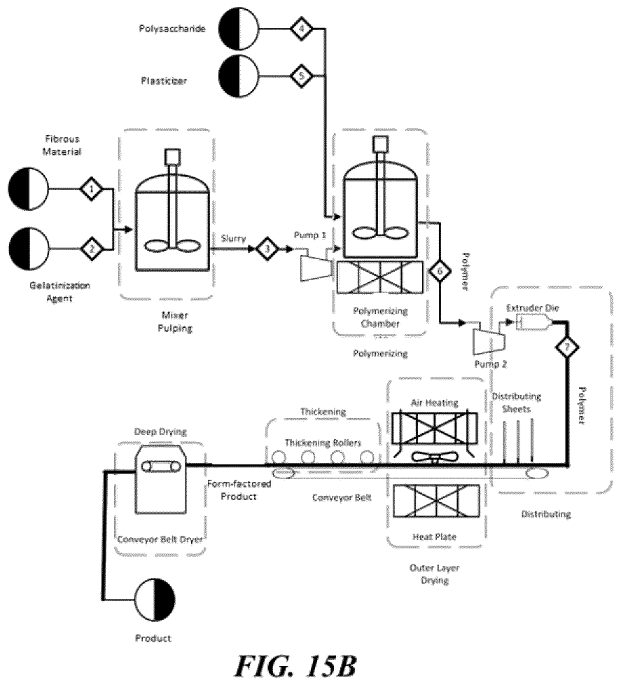

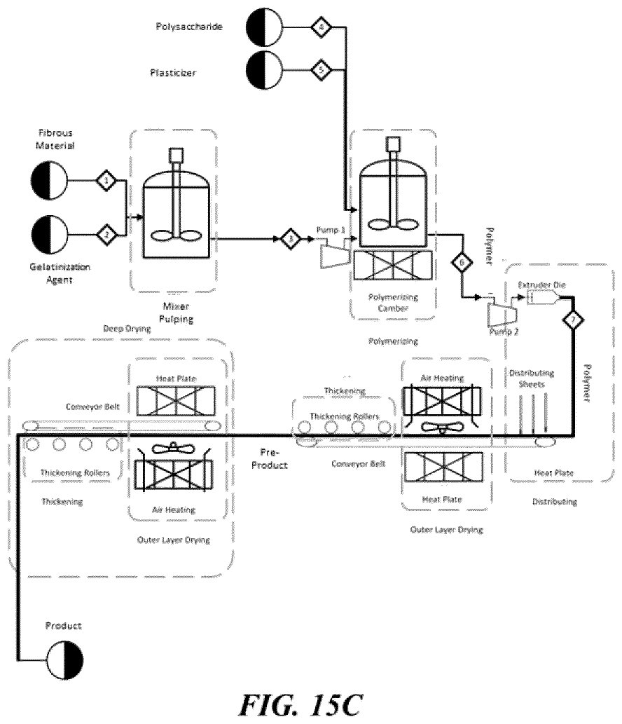

Methods for producing a composition described herein can be performed continuously, in a linear or parallel process. An example of a continuous, linear method is provided conceptually in FIG. 15A. As shown, the various operations of the example process continuously run and are performed in a simple series. The example process includes pulping, polymerizing, distribution, outer layer drying, thickening and deep drying operations to generate the product. An example of such a process is schematically depicted in FIG. 15B.

As shown in FIG. 15B, fibrous material and gelatinization agent are subjected to pulping to generate a slurry comprising both. The slurry is then pumped to reactor where it is combined with polysaccharide and plasticizer and heated to generate a polymer. The polymer is then pumped through an extruder which and delivered to a conveyor belt that transports the extruded polymer through distribution sheets for form-factoring as a film. The film is transported by the conveyor belt through an outer layer drying process that comprises both air heating and heating via a heat plate. The material is then subject to thickening through thickening rollers to generate a thickened product. The thickened product is then subject to deep drying in a conveyor belt dryer and the final product is then obtained. The process shown in FIG. 15B can also be run discretely, as described elsewhere herein.

Another example of a linear production process is schematically depicted in FIG. 15C. The example process is the same as the example process of FIG. 15B, except that the deep drying phase comprises subjecting the thickened material to another round of heating via a heat plate and air heating on a second conveyor belt, along with a further thickening stage to obtain the product. Multiple rounds of thickening can increase the transparency of the material and enhance other cosmetic properties. The process shown in FIG. 15C can alternatively be run discretely, as described elsewhere herein.

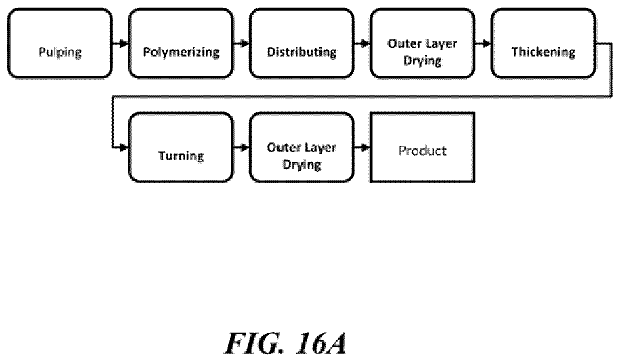

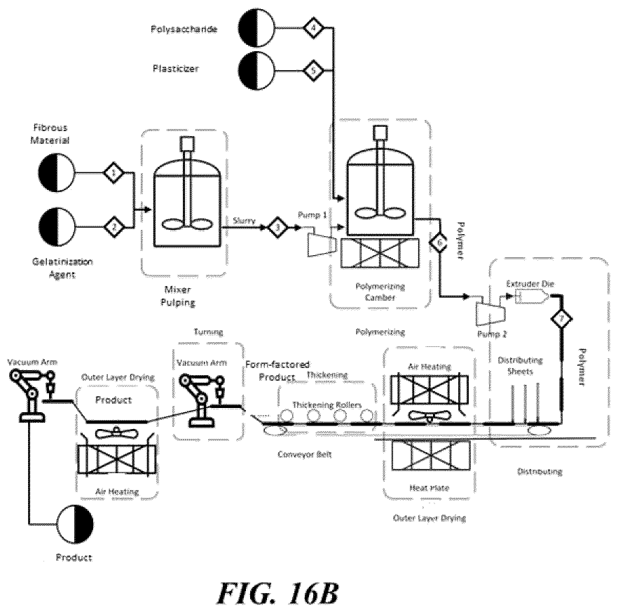

Methods for producing a composition described herein can be performed in batch and/or discretely. Discrete manufacturing can distribute material into portions of predefined dimension and/or form-factor, which can be customized. An example of such a method is provided conceptually in FIG. 16A. As shown, the various operations of the example process run discretely (e.g., without continuous production) and are performed in a simple series. The example process includes pulping, polymerizing, distribution, first outer layer drying, thickening, turning, and second outer layer drying operations to generate the product. An example of such a process is schematically depicted in FIG. 16B.

The example method of FIG. 16B is the same as the example method of FIG. 15B, except that, in addition to discrete processing, the material is turned (e.g., with a robotic vacuum arm, gantry vacuum system, an operator using a vacuum device) after its thickening. The turned product is then subject to a second outer layer drying stage (e.g., using air heating), then turned again to generate the product. In some cases, a discrete process may apply the outer layer drying process to the inner layer by adding a turning process at the end of the thickening process, as shown in FIGS. 16A and 16B. A vacuum arm is applied to absorb the form-factored product, via vacuum on its end effector, and transport the material to a second outer layer heating process for drying the inner layer. After the second outer layer drying process ends, the same vacuum arm releases the material into a stockpile, towards a converter that will manufacture the product. The extruder die can be adjusted to define the width of the material with the size of its die lips. The extruding time can be used to determine the length of the material.

### Example 8—Example Parallel Production Methods

Methods for producing a composition described herein can have parallel processing stages. Parallel processing stages can improve production efficiency (shorter manufacturing time and a higher production rate) over other processes.

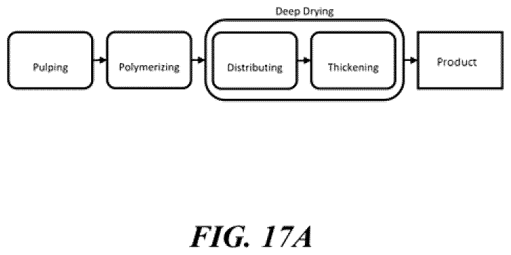

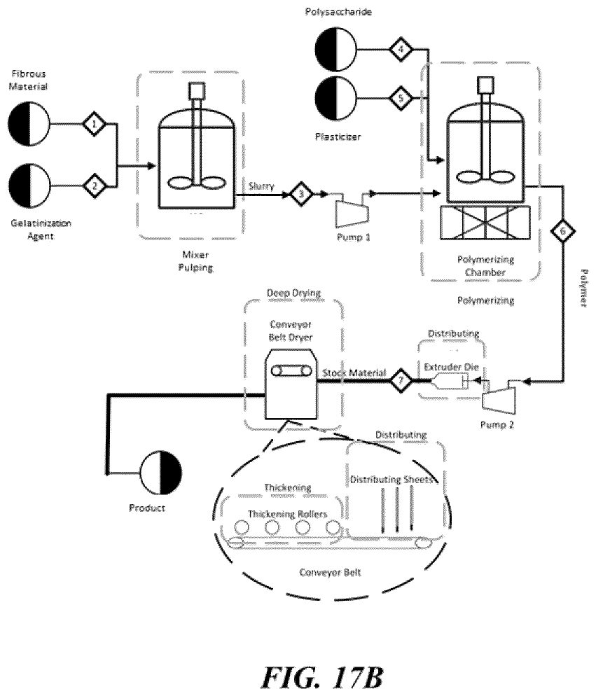

An example of such a method is provided conceptually in FIG. 17A. As shown, the various operations of the example run in series, except that the deep drying stage comprises both distribution and thickening. The example process includes pulping, polymerizing, deep drying (which includes distribution and thickening) to generate the product. An example of such a process is schematically depicted in FIG. 17B.

The example method of FIG. 17B is the same as the example method of FIG. 15B, except that the polymer generated in polymerization is extruded into a deep drying process, rather than an outer drying process, which is eliminated. In the deep drying process, polymer is subjected to distribution and thickening via a conveyor belt while drying occurs. The finished result is the end product.

### Example 9—Example Product Lifecycle and Recycle

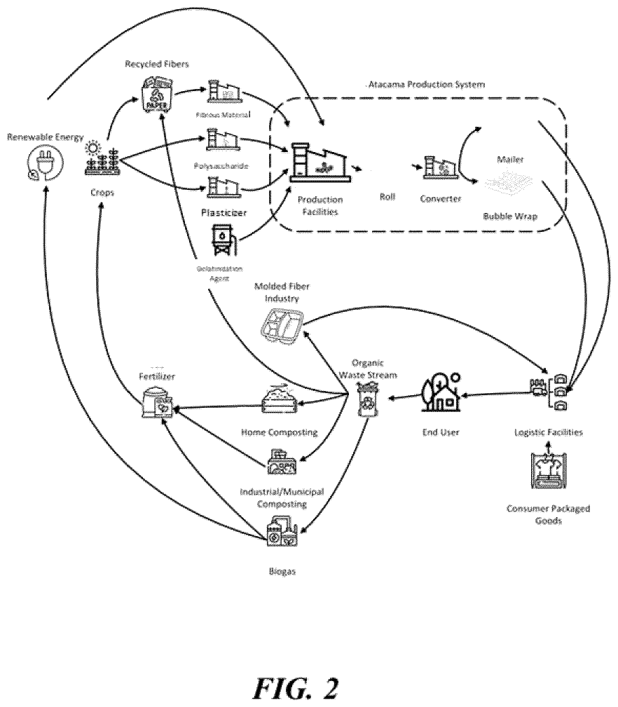

An example life cycle of compositions described herein is schematically depicted in FIG. 2. Indeed, compositions and methods described herein provide material alternatives that can aid in improving environmental outcomes. As shown in FIG. 2, crops, recycled materials and/or industrial waste from biomass processes can provide materials for generating compositions described herein using methods described herein. The compositions can be embodied in a variety of form factors which are then sent to their purchasers (e.g., logistics facilities) who then pass them on to consumers sometimes in the form of product packaging. Once consumer waste, the compositions described herein can be recycled or degraded in an environmentally-friendly manner via, for example, composting (e.g., for use as fertilizer), use as materials to generate biogas (e.g., for use to make fertilizer, generate renewable energy), and/or use in the molded fiber and papermaking industries. The compositions described herein can also be put back into the processes described herein to generate additional compositions.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-130. (canceled)

131. A composition, comprising:
a fibrous material;
a gelatinization agent;
a polysaccharide; and
a plasticizer,
wherein said fibrous material and said plasticizer are present at a weight-percent ratio of fibrous material to plasticizer from about 0.01 to about 10.

132. The composition of claim 131, (i) further comprising acetic acid, (ii) wherein said plasticizer is selected from the group consisting of glycerol, maltose, urea, sorbitol, sucrose, fructose, glucose, formamide, citric acid, amino acid, malic acid, ethylenebisformamide, buriti oil, polyethylene glycol, acetamide, ethanolamine, isoleucine, asparagine, ethanolamine, polyoils, lecithin, monoglycerides, propylene glycol, diethyleneoxide glycol, triethyleneoxide glycol and poliethyleneoxide glycol, or (iii) wherein said fibrous material is cellulose, anhydrocellulose, nanocellulose, or derivatives thereof.

133. The composition of claim 131, wherein said composition comprises a chemical structure of: 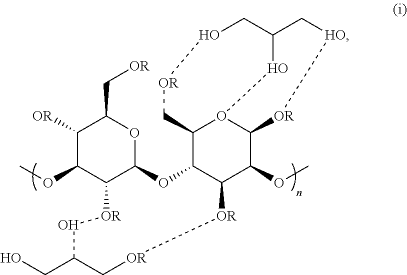
wherein R is an acetyl group or hydrogen, and wherein n is from about 1 to about 500; 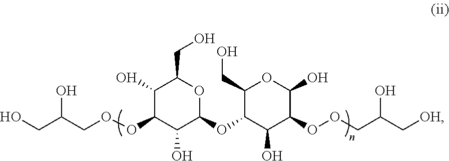
wherein n is from about 1 to about 500; or 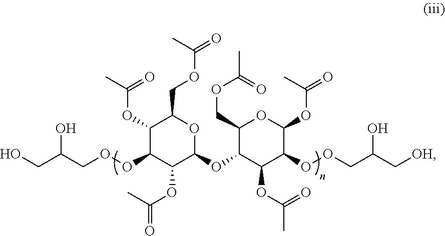
wherein n is from about 1 to about 500.

134. The composition of claim 131, wherein said plasticizer is coupled to said fibrous material via a non-covalent linkage.

135. The composition of claim 131, wherein said material is coupled to said fibrous material via a covalent linkage.

136. The composition of claim 131, wherein said composition is (i) biodegradable within about two years or (ii) recyclable.

137. The composition of claim 131, wherein (i) said polysaccharide and said gelatinization agent are present at a weight-percent ratio of polysaccharide to gelatinization agent from about 0.0001 to about 1 or (ii) said fibrous material and said gelatinization agent are present at a weight-percent ratio of fibrous material to gelatinization agent from about 0.0001 to about 1.

138. The composition of claim 131, wherein said composition comprises (i) a tensile strength of between about 0.1 megapascal (MPa) to about 200 (MPa), (ii) an elasticity of between about 0.1% and 1000%, or (iii) a modulus of elasticity of between 0.1 MPa to 2000 MPa.

139. The composition of claim 131, wherein said composition comprises a (i) tear propagation of between about 0.1 newtons (N) to about 50 N, (ii) a dynamic viscosity of between about 100 centipoise (cP) to about 5,000,000 cP, or (iii) a puncture strength of between about 1 N to about 75 N.

140. A method, comprising:
(a) providing a fibrous material, a polysaccharide, a gelatinization agent and a plasticizer to a reactor, thereby obtaining a mixture in said reactor; and
(b) in said reactor, heating material of said mixture at temperature(s) sufficient to transition said material through a plurality of material transition phases and thereby obtain a product, wherein said heating is performed for less than or equal to 30 minutes.

141. The method of claim 140, wherein, in (a), (i) said fibrous material, said polysaccharide, said plasticizer and said gelatinization agent are provided to said reactor simultaneously.

142. The method of claim 140, wherein, in (a), at least one of said fibrous material, said polysaccharide, said plasticizer and said gelatinization agent is provided separately to said reactor.

143. The method of claim 140, wherein said plurality of material transition phases comprises a gelatinization phase, a plastification phase and a fibrous bonding phase.

144. The method of claim 140, wherein said temperature(s) range from about 50° C. to about 400° C.

145. The method of claim 140, wherein (b) (i) comprises polymerization of one or more materials of said mixture or (ii) further comprises applying a shear stress to said mixture.

146. The method of claim 140, wherein, in (a), said fibrous material and said plasticizer are provided to said reactor at a weight-percent ratio of fibrous material to plasticizer from about 0.01 to about 10.

147. The method of claim 140, wherein, in (a), said fibrous material and said polysaccharide are provided to said reactor at a weight-percent ratio of fibrous material to polysaccharide from about 0.01 to about 10.

148. The method of claim 140, wherein, in (a), said polysaccharide and said gelatinization agent are provided to said reactor at a weight-percent ratio of polysaccharide to gelatinization agent from about 0.0001 to about 1.

149. The method of claim 140, wherein, in (a), said fibrous material and said gelatinization agent are provided to said reactor at a weight-percent ratio of fibrous material to gelatinization agent from about 0.0001 to about 1.

150. The method of claim 140, wherein (i) said mixture comprises acetic acid, (ii) said plasticizer is selected from the group consisting of glycerol, maltose, urea, sorbitol, sucrose, fructose, glucose, formamide, citric acid, amino acid, malic acid, ethylenebisformamide, buriti oil, polyethylene glycol, acetamide, ethanolamine, isoleucine, asparagine, ethanolamine, polyoils, lecithin, monoglycerides, propylene glycol, diethyleneoxide glycol, triethyleneoxide glycol and poliethyleneoxide glycol, or (iii) said fibrous material is cellulose, anhydrocellulose, nanocellulose, or derivatives thereof.
